(19) United States
(12) Patent Application Publication
(10) Pub. No.: US 2013/0181805 A1
(43) Pub. Date: Jul. 18, 2013

(54) ANTENNA MODULE, COMMUNICATION DEVICE AND METHOD OF MANUFACTURING ANTENNA MODULE

(71) Applicants: Norio Saito, Tochigi (JP); Katsuhisa Orihara, Tochigi (JP); Yoshito Ikeda, Tochigi (JP); Satoru Sugita, Tochigi (JP)

(72) Inventors: Norio Saito, Tochigi (JP); Katsuhisa Orihara, Tochigi (JP); Yoshito Ikeda, Tochigi (JP); Satoru Sugita, Tochigi (JP)

(73) Assignee: DEXERIALS CORPORATION, Tokyo (JP)

(21) Appl. No.: 13/824,860

(22) PCT Filed: Dec. 28, 2011
(86) PCT No.: PCT/JP2011/080444

§ 371 Date: Mar. 18, 2013

(30) Foreign Application Priority Data
Dec. 28, 2010 (JP) 2010-293402
Dec. 27, 2011 (JP) 2011-286177

(51) Int. Cl. H01F 38/14; H01F 41/06

(52) U.S. Cl. CPC H01F 38/14; H01F 41/065
USPC 336/84 M; 29/601

(57) ABSTRACT

A communication device that, when incorporated in an electronic device, can reduce the size and the thickness of a housing of the electronic device while maintaining communication characteristics. The communication device includes an antenna coil that is arranged on a peripheral part of a housing surface facing a reader-writer of a mobile phone, a magnetic sheet that attracts the magnetic filed transmitted from the reader-writer to the antenna coil, and a communication processing unit that is driven by a current flowing through the antenna coil and communicates with the reader-writer. The magnetic sheet is arranged to be closer to reader-writer than the antenna coil in the central part, and the antenna coil is arranged to be closer to the reader-writer on the outer periphery side, and at least a part of the conductive line of the antenna coil is superimposed in a direction orthogonal to a circuit board.

### FIELD OF THE INVENTION

The present invention relates to an antenna module that is incorporated in an electronic device and becomes communicable in response to a magnetic field transmitted from a transmitter, a communication device and a method of manufacturing an antenna module.

The present application asserts priority rights based on JP Patent Application No. 2010-293402 filed in Japan on Dec. 28, 2010 and JP Patent Application No. 2011-286177 filed in Japan on Nov. 27, 2011. The total contents of disclosure of the patent application of the senior filing date are to be incorporated by reference into the present application.

### BACKGROUND OF THE INVENTION

In an electronic device such as a mobile phone, in order to mount a function of noncontact short distance communication, an antenna module for RFID (Radio Frequency Identification) is used.

The antenna module communicates with an antenna coil mounted on a transmitter such as a reader-writer by using electromagnetic coupling. More specifically, the antenna module can drive an IC functioning a communication processing unit that causes the antenna coil to receive a magnetic field from the reader-writer to convert the magnetic field into electric power.

In the antenna module, magnetic fluxes having a certain value or more and transmitted from a reader-writer must be received by an antenna coil to reliably perform communication. In a conventional antenna module, a loop coil is arranged in the housing of a mobile phone, and the loop coil receives magnetic fluxes from a reader-writer.

However, in an antenna module incorporated in an electronic device such as a mobile phone, since a metal of a circuit board in the device or a battery pack reflects a magnetic fluxes from a reader-writer due to an eddy current generated by receiving a magnetic field from the reader-writer, the magnetic fluxes reaching the loop coil decrease. Since the magnetic fluxes reaching the loop coil decrease, the antenna module requires a loop coil having a certain opening area to collect required magnetic fluxes. Furthermore, the magnetic fluxes must be increased by using a magnetic sheet.

As described above, although magnetic fluxes from the reader-writer are reflected by an eddy current flowing in the circuit board of an electronic device such as a mobile phone, a component of a magnetic field along a plane direction of the circuit board is present on a housing surface of the electronic device. A technique in which a coil is caused to function as antenna by receiving the component is described in Patent Document 1. More specifically, in Patent Document 1, an antenna structure obtained by winding a coil on a ferrite core to reduce an occupied area of a coil is described.

### PRIOR-ART DOCUMENTS

### Patent Document

PTL1: Japanese Patent Application Laid-Open No. 2008-35464

### SUMMARY OF THE INVENTION

As described above, since a good conductor such as a circuit board that relatively easily conducts electricity is used in the electronic device such as a mobile phone, when an eddy current is generated on the circuit board that receives a magnetic field, magnetic fluxes are reflected. For example, on a housing surface of the mobile phone, a magnetic field radiated from a reader-writer tends to be strong at an outer peripheral part of the housing surface and to be weak near the center of the housing surface.

In an antenna using a normal loop coil, an opening of the loop coil is located at a central part of a mobile phone in which a magnetic field passing through the outer peripheral part of the housing surface can be rarely received. For this reason, in the antenna using the normal loop coil, efficiency of receiving a magnetic field is poor.

In the antenna structure described in Patent Document 1, since a sectional area of a ferrite core is in proportion to a magnetic flux density, the thickness of the ferrite core must be 1 mm or more, and a housing of a mobile phone has a relatively thick structure. For this reason, the antenna described in Patent Document 1 cannot be easily mounted in a thin mobile phone. Furthermore, when an antenna module is incorporated on a back side of a liquid crystal display mounted on a flip phone, the antenna module is required to be thin. For this reason, the antenna structure described in Patent Document 1 is difficult to be mounted on the flip phone.

An antenna module incorporated in a mobile phone or the like is desired to realize high communication characteristics by increasing the number of turns of an antenna coil while reducing a housing of an electronic device in size when the antenna module is incorporated in the electronic device.

The present invention has been proposed in consideration of the above circumstances, and has as its object to provide an antenna module that can realize high communication characteristics while reducing a housing of an electronic device when the antenna module is incorporated in the electronic device, a communication device and a method of manufacturing an antenna module.

In order to solve the above problem, according to the present invention, an antenna module that is incorporated in an electronic device and becomes communicable in response to a magnetic field transmitted from a transmitter includes: an antenna coil that is arranged on an outer peripheral part of a housing surface facing the transmitter of the electronic device and electromagnetically coupled to the transmitter; and a magnetic sheet that attracts a magnetic field transmitted from the transmitter to the antenna coil, wherein the antenna coil and the magnetic sheet are superimposed in a direction orthogonal to the housing surface such that the antenna coil is arranged to be closer to the transmitter than the magnetic sheet on an outer peripheral side of the housing surface and the magnetic sheet is arranged to be closer to the transmitter than the antenna coil on a center side of the housing surface, and the antenna coil is arranged such that at least a part of a conductive line is superimposed in the direction orthogonal to the housing surface.

A communication device according to the present invention that is incorporated in an electronic device and becomes communicable in response to a magnetic field transmitted from a transmitter including: an antenna coil that is arranged on an outer peripheral part of a housing surface facing the transmitter of the electronic device and electromagnetically coupled to the transmitter; a magnetic sheet that attracts a magnetic field transmitted from the transmitter to the antenna coil; and a communication processing unit that is driven by a current flowing in the antenna coil and communicates with the transmitter, wherein the antenna coil and the magnetic sheet are superimposed in a direction orthogonal to the housing surface such that the antenna coil is arranged to be closer to the transmitter than the magnetic sheet on an outer peripheral side of the housing surface and the magnetic sheet is arranged to be closer to the transmitter than the antenna coil on a center side of the housing surface, and the antenna coil is arranged such that at least a part of a conductive line is superimposed in the direction orthogonal to the housing surface.

A method of manufacturing an antenna module, in an antenna module that is incorporated in an electronic device and becomes communicable in response to a magnetic field transmitted from a transmitter includes: the step of preparing an antenna coil that is arranged on an outer peripheral part of a housing surface facing the transmitter of the electronic device and electromagnetically coupled to the transmitter; and the step of preparing a magnetic sheet that attracts a magnetic field transmitted from the transmitter to the antenna coil. The antenna coil and the magnetic sheet are superimposed in a direction orthogonal to the housing surface such that the antenna coil is arranged to be closer to the transmitter than the magnetic sheet on an outer peripheral side of the housing surface and the magnetic sheet is arranged to be closer to the transmitter than the antenna coil on a center side of the housing surface, and the antenna coil is arranged such that at least a part of a conductive line is superimposed in the direction orthogonal to the housing surface.

### EFFECTS OF INVENTION

According to the present invention, since the antenna coil and the magnetic sheet are superimposed in a direction orthogonal to the housing surface such that the antenna coil is arranged to be closer to the transmitter than the magnetic sheet on an outer peripheral side of the housing surface and the magnetic sheet is arranged to be closer to the transmitter than the antenna coil on a center side of the housing surface, magnetic fluxes generated on the outer peripheral part of the housing surface of the electronic device facing the transmitter can be efficiently attracted to the antenna coil.

Furthermore, according to the present invention, since at least one part of the conductive line of the antenna coil is superimposed in the direction orthogonal to the housing surface, the number of turns of the antenna coil can be increased while suppressing a resistance from increasing depending on the line width of the conductive line and a coil area in the direction of the housing surface from increasing. For this reason, high communication characteristics can be realized.

Thus, the present invention can realize high communication characteristics while reducing the housing of the electronic device in size when the antenna coil is incorporated in the electronic device.

### BRIEF DESCRIPTION OF DRAWINGS

FIG. 1 is an exploded perspective view for explaining a configuration of a wireless communication system in which a communication device to which the present invention is applied is incorporated.

FIG. 2 is a perspective view for explaining a configuration of a communication device arranged in a housing of a mobile phone.

FIG. 3A is a perspective view of an antenna circuit board according to a comparative example, and FIG. 3B is a sectional view of the antenna circuit board according to the comparative example.

FIG. 4A is a plan view showing an outer shape of an antenna coil according to a comparative example in which the number of turns is 3, and FIG. 4B is a plan view showing an outer shape of an antenna coil according to a comparative example in which the number of turns is 6.

FIG. 5A is a graph showing a change in resistance of the antenna coil and a change in inductance when the number of turns is changed under the condition in which outside dimensions are constant in the comparative example. FIG. 5B is a graph showing a change in Q value when the number of turns is changed under the condition in which outside dimensions are constant in the comparative example.

FIG. 6 is a graph showing a mutual inductance and a coupling coefficient between a reader-writer and an antenna when the number of turns is changed under the condition in which outside dimensions are constant of the antenna coil are constant in the comparative example.

FIGS. 7A to 7C are diagrams for explaining a configuration of a communication device according to a first embodiment. FIG. 7A is an exploded perspective view of the communication device, and FIG. 7B is a perspective view of the communication device. FIG. 7C is a diagram typically showing a state in which the communication device is mounted on a circuit board in a mobile phone.

FIGS. 8A and 8B are perspective views for explaining a terminal structure of a terminal unit of the antenna coil in the first embodiment. FIG. 8A shows a case in which the coil is connected in parallel, and FIG. 8B shows a case in which the coil is connected in series.

FIG. 9 is a graph showing a change in Q value of the antenna coil when a width W of the antenna coil regulated in a y-axis direction in the first embodiment.

FIG. 10 is a graph showing a change in coupling coefficient between a reader-writer and the antenna when the width w of the antenna coil regulated in the y-axis direction in the first embodiment.

FIG. 11 is a plan view of a communication device for explaining a value that regulates a superimposing state of two coils configuring the antenna coil under the conditions in which outside dimensions of the antenna coil regulated as a width W and a length L are set to be constant, i.e., 20 mm and 20 mm, respectively.

FIGS. 12A and 12B are diagrams for explaining a superimposing state in which the two coils are inserted into a magnetic sheet 13 such that almost—½ regions of the coils are superimposed on each other when a=0 [mm]. FIG. 12A is a plan view of the communication device, and FIG. 12B is a perspective view of the communication device.

FIGS. 13A and 13B are diagrams for explaining a superimposing state in which the two coils are inserted into the magnetic sheet 13 such that almost—¼ regions of the coils are superimposed on each other when a=−4.2 [mm]. FIG. 13A is a plan view of the communication device, and FIG. 13B is a perspective view of the communication device.

FIGS. 14A and 14B are diagrams for explaining a superimposing state in which the two coils are inserted into the magnetic coil sheet 13 such that almost—¾ regions of the coils are superimposed on each other when a=8.2 [mm]. FIG. 14A is a plan view of the communication device, and FIG. 14B is a perspective view of the communication device.

FIGS. 15A and 15B are diagrams for explaining a superimposing state in which the two coils are inserted into the magnetic coil sheet 13 such that the coils are almost completely superimposed on each other to coincide with each other when a=10.8 [mm]. FIG. 15A is a plan view of the communication device, and FIG. 15B is a perspective view of the communication device.

FIG. 16 is a diagram showing changes in resistance and inductance obtained when superimposing states between the two coils are changed by changing a value a [mm].

FIG. 17 is a diagram showing a change in Q value when superimposing states between the two coils are changed.

FIG. 18 is a graph showing a change in coupling coefficient between a reader-writer and the antenna when superimposing states between the two coils are changed by changing the value a [mm].

FIGS. 19A and 19B are diagrams for explaining a modification of the communication device according to the first embodiment. FIG. 19A is an exploded perspective view of the communication device, and FIG. 19B is a perspective view of the communication device.

FIG. 20 is a diagram for explaining a configuration of a communication device according to a second embodiment, and is a perspective view showing a state in which an antenna circuit board that has been not assembled is developed.

FIG. 21 is a diagram for explaining the configuration of the communication device according to the second embodiment, and is a perspective view showing a state in which a magnetic sheet is mounted on an antenna circuit board.

FIG. 22 is a diagram for explaining the configuration of the communication device according to the second embodiment, and is a perspective view showing a state in which the antenna circuit board is folded.

FIG. 23 is a diagram for explaining the configuration of the communication device according to the second embodiment, and is a perspective view showing a state in which the antenna circuit board is folded back and is completed as a communication device.

FIG. 24 is a diagram for explaining the configuration of the communication device according to the second embodiment, and is a diagram typically showing a state in which the communication device is mounted on a circuit board in a mobile phone.

FIG. 25 is a diagram for explaining a change of characteristics when a width W of an antenna coil regulated in a y-axis direction is changed in the second embodiment and a comparative example.

FIG. 26 is a graph showing a change in Q value of the antenna coil when the width w of the antenna coil regulated in the y-axis direction is changed in the second embodiment and the comparative example.

FIG. 27 is a graph showing a change in coupling coefficient between a reader-writer and an antenna when the width w of the antenna coil regulated in the y-axis direction is changed in the second embodiment and the comparative example.

FIGS. 28A to 28C are plan views the communication device to explain a value b that regulates a superimposing state of two coils configuring the antenna coil under the condition in which outside dimensions of the antenna coil regulated by a width W and a length L are set to be constant, i.e., 20 mm and 20 mm, respectively, in the second embodiment. FIG. 28A shows a case in which b=0 mm, FIG. 28B shows a case in which b=1 mm, FIG. 28C shows a case in which b=3 mm.

FIG. 29 is a graph showing a change in Q value when superimposing states between the two coils are changed by changing a value b [mm].

FIG. 30 is a graph showing a change in coupling coefficient between a reader-writer and an antenna when superimposing states of the two coils are changed by changing the value b [mm].

FIGS. 31A to 31C are diagrams for explaining a configuration of a modification of the second embodiment. FIG. 31A is a perspective view showing a shape of a coil formed by a conductive line on a developed printed-circuit board. FIG. 31B is a perspective view showing a state in which a magnetic sheet is mounted on the coil. FIG. 31C is a perspective view showing a state in which both ends of the printed-circuit board are folded on the upper surface side of the magnetic sheet to form a communication device.

FIG. 32 is a diagram for explaining a configuration of the modification of the second embodiment, and a diagram typically showing a state in which the communication device is mounted on a circuit board in a mobile phone.

FIG. 33 is a graph showing a change in coupling coefficient between a reader-writer and an antenna when a width W of an antenna coil is changed in the modification of the second embodiment and a comparative example.

FIG. 34 is a graph showing a change in Q value of the antenna coil when the width W of the antenna coil is changed in the modification of the second embodiment and the comparative example.

FIGS. 35A and 35B are diagrams showing variations of the communication device according to the modification of the second embodiment. FIG. 35A is a perspective view showing a case in which a magnetic sheet having a thickness of about 1 mm, and FIG. 35B is a perspective view showing a case in which a magnetic sheet having a thickness of about 3 mm is used.

FIGS. 36A to 36C are diagrams for explaining another modification of the second embodiment. FIG. 36A is a perspective view showing a shape of a coil formed by a conductive line on a developed printed-circuit board. FIG. 36B is a perspective view showing a state in which a magnetic sheet is mounted on a coil. FIG. 36C is a perspective view showing a state in which both ends of the printed-circuit board are folded on an upper surface side and a lower surface side of a magnetic sheet to form a communication device.

FIG. 37 is a diagram for explaining a configuration of another modification of the second embodiment, and a diagram typically showing a state in which a communication device is mounted on a circuit board in a mobile phone.

FIGS. 38A and 38B are diagrams for explaining a third embodiment. FIG. 38A is an exploded perspective view of a communication device in which a shape of a coil formed by a conductive line on a first printed-circuit board, a magnetic sheet, and a shape of a coil formed by a conductive line on a second printed-circuit board are shown. FIG. 38B is a perspective view showing a state in which elements in FIG. 38A are laminated and a conductive line is electrically connected to form a communication device.

FIG. 39 is a diagram for explaining a configuration of a communication device according to the third embodiment, and is a diagram typically showing a state in which the communication device is mounted on a circuit board of a mobile phone.

FIG. 40A is a perspective view showing an antenna circuit board arranged on an outer peripheral part on an outer peripheral side 130d side, FIG. 40B is a perspective view showing an antenna circuit board arranged on an outer peripheral part on another outer peripheral side 130b side, FIG. 40C is a perspective view showing an antenna circuit board arranged on an outer peripheral part on still another outer peripheral side 130a side, and FIG. 40D is a perspective view showing an antenna circuit board arranged on an outer peripheral part on still another outer peripheral side 130c side.

FIG. 41A is a perspective view showing two antenna circuit boards arranged on the outer peripheral parts on the outer peripheral side 130b side and the outer peripheral side 130d side, and FIG. 41B is a perspective view showing two antenna circuit boards arranged on the outer peripheral parts of the outer peripheral side 130a side and the outer peripheral side 130c side.

FIG. 42A is a perspective view showing three antenna circuit boards arranged on the outer peripheral parts on the outer peripheral side 130a side, the outer peripheral side 130b side, and the outer peripheral side 130c side. FIG. 42B is a perspective view showing two antenna circuit boards arranged on the outer peripheral parts on the outer peripheral side 130a side, the outer peripheral side 130b side, and the outer peripheral side 130c side.

FIG. 43 is a perspective view showing four antenna circuit boards arranged on the outer peripheral parts on the outer peripheral side 130a side, the outer peripheral side 130b side, the outer peripheral side 130c side, and the outer peripheral side 130d side.

### DETAILED DESCRIPTION OF THE INVENTION

Embodiments of the present invention will be described below in detail with reference to the accompanying drawings. The present invention is not limited to only the following embodiments, and various changes can be effected without departing from the gist of the present invention.

### <Entire Configuration>

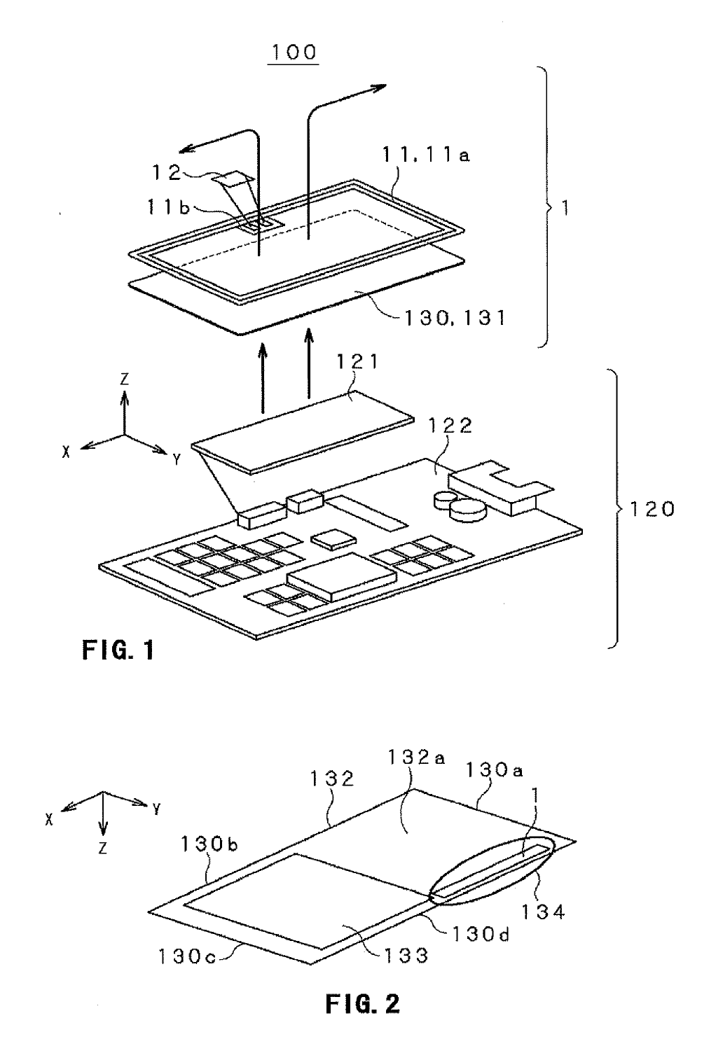

A communication device to which the present invention is applied is a device that is incorporated in an electronic device and becomes communicable in response to a magnetic field transmitted from a transmitter, and is used by being incorporated in a wireless communication system 100 for RFID (Radio Frequency Identification) as shown in, for example, FIG. 1.

The wireless communication system 100 includes a communication device 1 according to a first embodiment to which the present invention is applied, and a reader-writer 120 that accesses the communication device 1. The communication device 1 and the reader-writer 120 are arranged to face each other on an x-y plane of a three-dimensional orthogonal coordinate system xyz.

The reader-writer 120 functions a transmitter that transmits a magnetic field in a z-axis direction to the communication device 1 facing the reader-writer 120 on the x-y plane. More specifically, the reader-writer 120 includes an antenna 121 that transmits a magnetic field to the communication device 1 and a control circuit board 122 that communicates with the communication device 1 electromagnetically coupled to the control circuit board 122 through the antenna 121.

More specifically, in the reader-writer 120, the control circuit board 122 electrically connected to the antenna 121 is arranged. On the control circuit board 122, a control circuit including electronic parts such as one integrated circuit chip or a plurality of integrated circuit chips is mounted. The control circuit executes various processes on the basis of data received from the communication device 1. For example, when the control circuit transmits data to the communication device 1, the control circuit encodes data, modulates a carrier wave having a predetermined frequency (for example, 13.56 MHz) on the basis of the encoded data, amplifies the modulated modulation signal, and drives the antenna 121 by the amplified modulation signal. When the control circuit reads data from the communication device 1, the control circuit amplifies the modulation signal of the data received by the antenna 121, demodulates the amplified modulation signal of the data, and decodes the demodulated data. In the control circuit, an encoding scheme and a modulation scheme used in a general reader-writer are used. For example, Manchester encoding or ASK (Amplitude Shift Keying) modulation are used.

The communication device 1, for example, is incorporated in a housing 131 of a mobile phone 130 arranged to face the reader-writer 120 on an x-y plane. The communication device 1 includes an antenna circuit board 11 on which an antenna coil 11a that can communicate with the reader-writer 120 electromagnetically coupled to the antenna coil 11a, and a communication processing unit 12 that is driven by a current flowing in the antenna coil 11a and communicates with the reader-writer 120.

On the antenna circuit board 11, the antenna coil 11a formed by performing a patterning process or the like to a flexible conductive line such as a flexible flat cable and a terminal unit 11b that electrically connects the antenna coil 11a and the communication processing unit 12 to each other are mounted.

When the antenna coil 11a receives a magnetic field transmitted from the reader-writer 120, the antenna coil 11a is electromagnetically coupled to the reader-writer 120, and receives a modulated electromagnetic wave to supply a received signal to the communication processing unit 12 through the terminal unit 11b.

The communication processing unit 12 is driven by a current flowing in the antenna coil 11a, and communicates with the reader-writer 120. More specifically, the communication processing unit 12 demodulates the received modulation signal, decodes the demodulated data, and writes the decoded data in an internal memory held in the communication processing unit 12. The communication processing unit 12 reads data to be transmitted to the reader-writer 120 from the internal memory, encodes the read data, modulates a carrier wave on the basis of the encoded data, and transmits a radio wave modulated through the antenna coil 11a coupled by electromagnetic induction to the reader-writer 120.

In the wireless communication system 100 having the above configuration, configurations of the communication device 1 according to the embodiment and a communication device 201 according to a comparative example will be described below.

The communication device 1 according to the embodiment and the communication device 201 according to the comparative example must maintain communication characteristics with the reader-writer 120. Furthermore, when the communication device 1 or 201 is incorporated in an electronic device such as the mobile phone 130, in terms of realization of a reduction in size and thickness of the electronic device, for example, on the x-y plane as shown in FIG. 2, the communication device 1 or the communication device 201 is arranged on a circuit board 132 in the housing 131 of the mobile phone 130. In FIG. 2, in a region of a part of the circuit board 132, a magnetic sheet 133 is arranged to cover a battery pack to drive the mobile phone 130.

An antenna coil 211a of the communication device 201 (will be described later) is preferably arranged at a position where the intensity of a magnetic field from the reader-writer 120 is high to maintain communication characteristics between the antenna coil 211a and the reader-writer 120. In this case, since the circuit board 132 of the mobile phone 130 relatively easily conducts electricity, when an external AC magnetic field is applied to the circuit board 132 to generate an eddy current, thereby reflecting a magnetic field. When a magnetic field distribution obtained when the external AC magnetic field is applied is examined, the magnetic fields of the four outer peripheral sides 130a, 130b, 103c, and 130d on the surface of the housing 131 of the mobile phone 130 arranged to face the reader-writer 120 tend to be strong.

By using the tendency of a magnetic field intensity in the housing 131 of the mobile phone 130, the communication device 1 according to the embodiment and the communication device 201 according to the comparative example, as shown in FIG. 2, are arranged on an outer peripheral part 134 on the outer peripheral side 130d side of the outer peripheral sides 130a, 130b, 130c, and 130d having the strong magnetic fields. In this manner, the communication device 1 or 201 can be arranged at a portion having a relatively high magnetic field intensity on the circuit board 132 of the mobile phone 130.

### Comparative Example

Prior to the explanation of the communication device 1 according to the embodiment, a concrete configuration of the communication device 201 according to the comparative example will be described below.

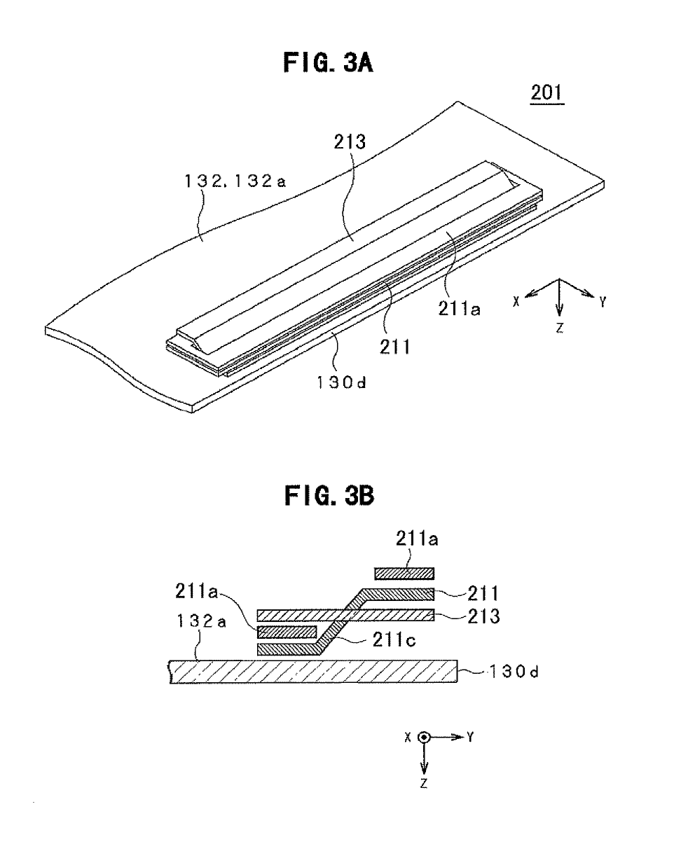

A magnetic field of the outer peripheral part 134 on which the communication device 201 according to the comparative example is arranged has a large magnetic field component in the planar direction of the circuit board 132, more specifically, a large magnetic field component in a y-axis direction from a central part 132a of the circuit board 132 to the outer peripheral side 130d. In order to efficiently attract a component of a magnetic field extending from the central part 132a of the circuit board 132 to the outer peripheral side 130d to the antenna coil 211a, the communication device 201 include a magnetic sheet 213 arranged as shown in FIG. 3 and superimposed on the antenna coil 211a.

In this case, FIG. 3A is a perspective view of an antenna circuit board 211 into which the magnetic sheet 213 is inserted on the x-y plane, and FIG. 3B is a sectional view of the antenna circuit board 211 into which the magnetic sheet 213 is inserted in an insertion direction parallel to the y axis on the x-y plane. In the communication device 201 shown in FIG. 3, the number of turns of the antenna coil 211a is set to 1.

As shown in FIG. 3B, in the communication device 201 according to the comparative example, the magnetic sheet 213 is inserted into a central part 211c of the antenna coil 211a formed on the antenna circuit board 211. On the central part 132a side of the circuit board 132, the magnetic sheet 213 is arranged to be closer to the reader-writer 120 than the antenna coil 211a. On the outer peripheral side 130d side of the circuit board 132, the antenna coil 211a is arranged to be closer to the reader-writer 120 than the magnetic sheet 213.

In this case, as the antenna circuit board 211, as described above, the flexible printed-circuit board, a rigid printed-circuit board, or the like is used. In particular, by using the flexible printed-circuit board, the central part of the antenna coil 211a is notched, an opening can be easily formed, and the magnetic sheet 213 can be easily inserted into the opening. In the communication device 201, in terms of that the magnetic sheet 213 is easily inserted into the antenna circuit board 211, the antenna circuit board 211 is formed by using the flexible printed-circuit board. Similarly, communication devices 1 and 2 according to the embodiment (will be described later), in terms of that the magnetic sheet is easily inserted into the antenna circuit board, the antenna circuit board is preferably formed by using the flexible printed-circuit board. More specifically, by using the flexible printed-circuit board, the communication device 201 and communication devices 1, 2, and 3 according to the embodiments (will be described later can be easily manufactured.

In the communication device 201, on the central part 132a side of the circuit board 132, the magnetic sheet 213 is arranged to be closer to the reader-writer 120 than the antenna coil 211a. On the outer peripheral side 130d side of the circuit board 132, the antenna coil 211a is arranged to be located on the reader-writer 120 side. In this manner, a magnetic field generated on the outer peripheral part 134 can be efficiently attracted to the antenna coil 211a.

The magnetic field generated on the outer peripheral part 134 can be efficiently attracted to the antenna coil 211a because the magnetic sheet 213 is arranged such that a magnetic field component from the central part 132a of the circuit board 132 to the outer peripheral side 130d efficiently pass through the opening of the antenna coil 211a.

In this case, in order to improve communication characteristics of the antenna coil, in general, the number of turns of the coil (to be simply referred to as “the number of turns” hereinafter) may be increased. In the antenna coil 211a of the communication device 201 according to the comparative example, as described above, in consideration of arranged on the outer peripheral part 134 on the outer peripheral side 130d side, outside dimensions of the antenna coil are difficult to be increased. For this reason, the number of turns must be increased under the condition in which the outside dimensions are constant.

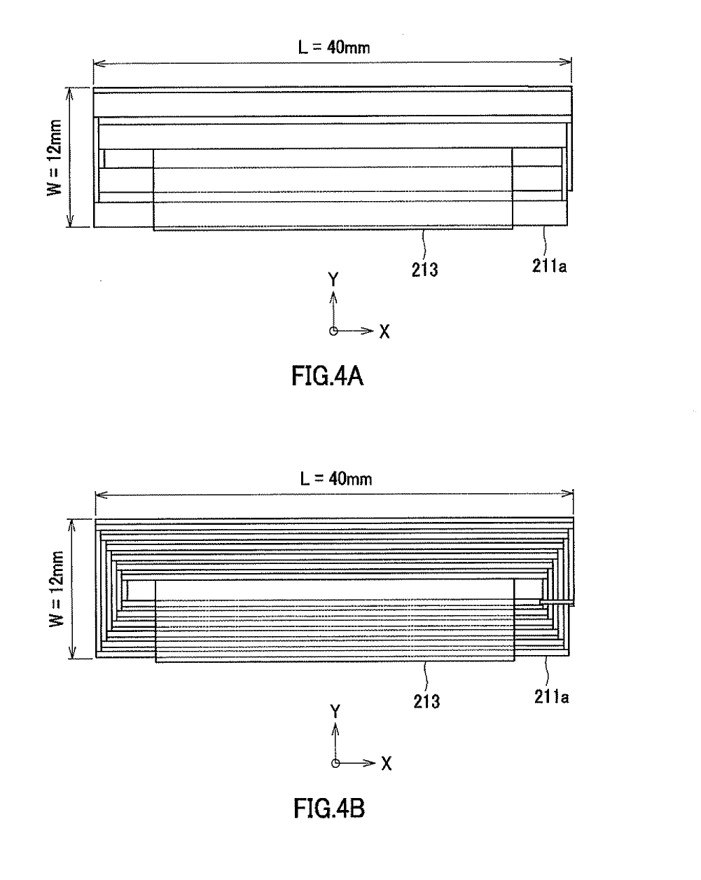

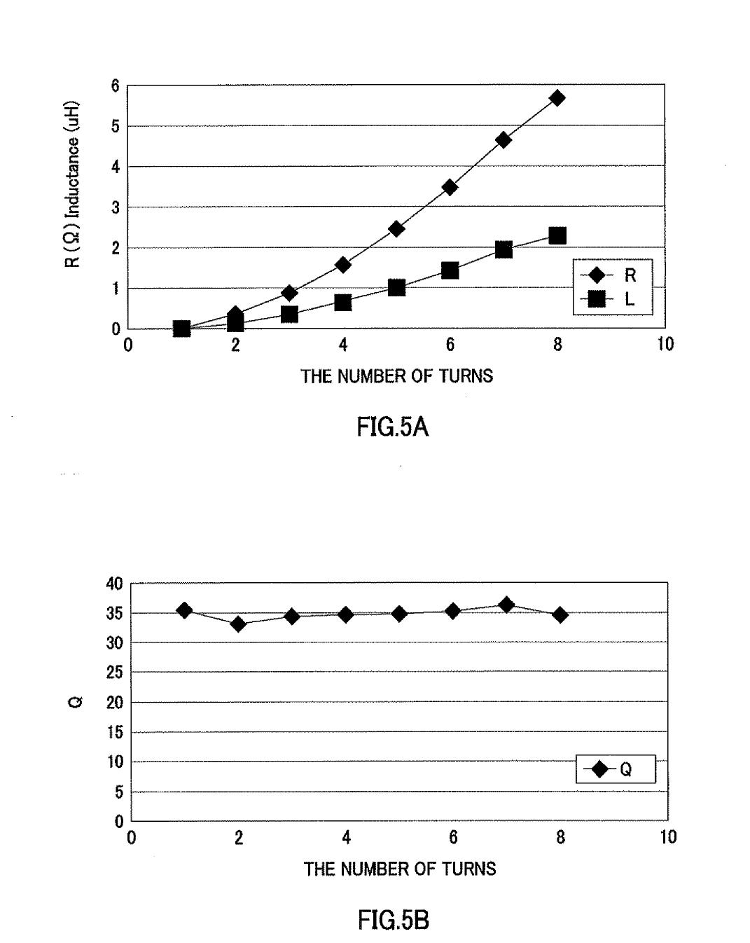

In a case in which the number of turns is changed under the above condition, a resistance of the antenna coil 211a, a self-inductance (to be simply referred to as an “inductance” hereinafter) value, and a Q value will be described with reference to FIGS. 4 to 5. The Q value is one of evaluation indexes of an antenna coil, and is expressed by Q=ωL/R when reference symbol w denotes an angular frequency corresponding to a communication frequency; L denotes an inductance; and R denotes a resistance.

FIG. 4A is a diagram showing an outer shape of the antenna coil 211a having the number of turns that is 2, and FIG. 4B is a diagram showing an outer shape of the antenna coil 211a having the number of turns that is 6. It is assumed that, the outer shape of the antenna coil 211a shown in FIGS. 4A and 4B is defined such that a width W regulated in a y-axis direction is 12 mm and a length L regulated in an x-axis direction is 40 mm. When the number of turns is increased under the condition in which the outside dimensions are set to be constant, the line width of a conductive line becomes narrow. As is apparent from a result shown in FIG. 5, a resistance becomes high.

FIG. 5A is a graph showing a change of a resistance R of the antenna coil 211a and a change of an inductance L when the number of turns is changed under the condition in which the outside dimensions are constant. FIG. 5B is a graph showing a change in Q value of the communication device 201 when the number of turns of the antenna coil 211a is changed under the condition in which the outside dimensions are constant.

As is apparent from FIG. 5, under the condition in which the outside dimensions of the antenna coil 211a are constant, when the number of turns is increased, the inductance L increases. However, since the resistance R also increases, the Q value does not become high.

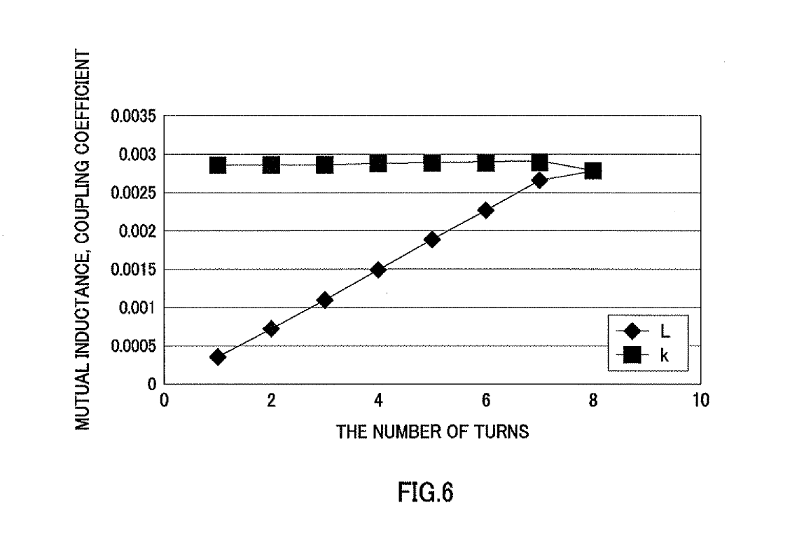

Furthermore, FIG. 6 shows changes in mutual inductance and coupling coefficient between the communication device 201 and the antenna 121 of the reader-writer 120 when the number of turns is changed under the condition in which the outside dimensions of the antenna coil 211a are constant. As is apparent from FIG. 6, the inductance L increases when the number of turns increases, and a coupling coefficient k does not change even though the number of turns increases.

In this manner, under the condition in which the outside dimensions of the antenna coil 211a are constant, communication characteristics are difficult to be improved even though the number of turns is increased, and the communication characteristics are difficult to be improved by reducing the outer shape of the antenna coil in size.

### First Embodiment

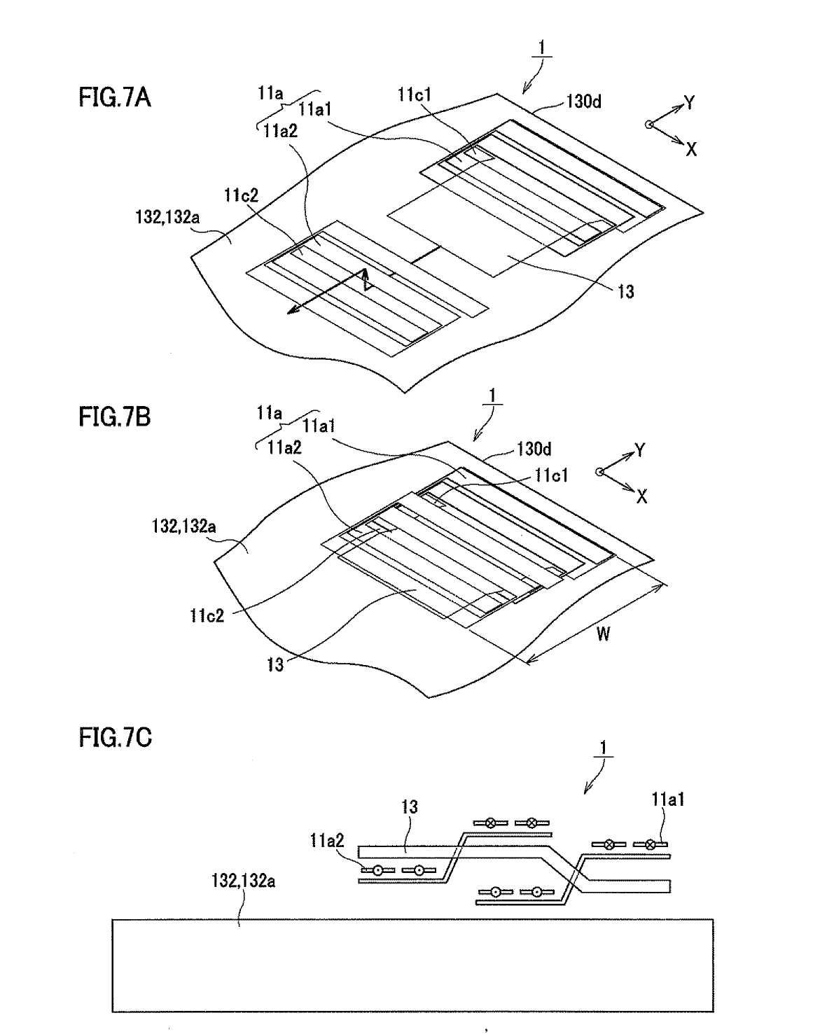

With respect to the communication device 201 according to the comparative example, as the first embodiment, in the communication device 1, communication characteristics are improved by increasing the number of turns without narrowing the line width of a conductive line of an antenna coil. For this reason, as shown in FIG. 7, an antenna coil 11a includes two antenna coils 11a1 and 11a2. It is assumed that each of the coils 11a1 and 11a2 has the same shape and the number of turn that is 2.

In the communication device 1, first, as shown in FIG. 7A, a magnetic sheet 13 is inserted into an opening 11c1 of the coil 11a1. On the central part 132a side of the circuit board 132, the magnetic sheet 13 is arranged to be closer to the reader-writer 120 than the coil 11a1. On the outer peripheral side 130d side of the circuit board 132, the coil 11a1 is arranged to be closer to the reader-writer 120 than the magnetic sheet 13. In the communication device 1, as shown in FIG. 7A, the magnetic sheet 13 into which the coil 11a1 is inserted is inserted into an opening 11c2 of the coil 11a2. On the central part 132a side of the circuit board 132, the magnetic sheet 13 is arranged to be closer to the reader-writer 120 than the coil 11a2. On the outer peripheral side 130d side of the circuit board 132, the coil 11a2 is arranged to be closer to the reader-writer 120 than the magnetic sheet 13. In this case, it is assumed that the coils 11a1 and 11a2, as shown in the sectional view in FIG. 7C, in a shape regulated in a planar direction of the circuit board 132, are inserted into the magnetic sheet 13 such that half regions of the coils 11a1 and 11a2 are superimposed on each other.

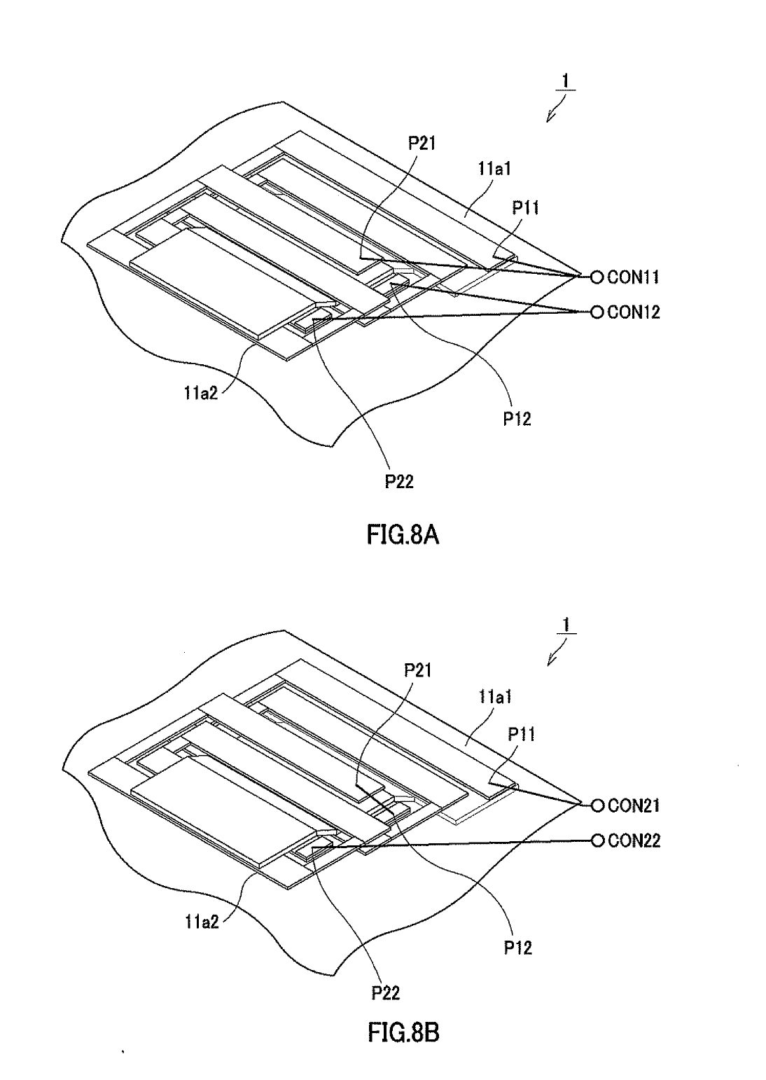

In the communication device 1, the coils 11a1 and 11a2 are connected in series with or in parallel to each other to function as one antenna coil 11a. However, as a terminal unit 11b connected to a communication processing unit 12, a terminal structure as described below may be employed. More specifically, the terminal unit 11b, as shown in FIG. 8A, has an input/output terminal structure configured by terminals CON11 and CON12 that connect the coils 11a1 and 11a2 in parallel to each other. Furthermore, as shown in FIG. 8B, the terminal unit 11b has an input/output terminal structure configured by the terminals CON 11 and CON 12 that connect the coils 11a1 and 11a2 in series with each other.

In this case, when terminals P11 and P12 are defined as end portions of the conductive line of the coil 11a1, respectively, and when terminals P21 and P22 are defined as end portions of the conductive line of the coil 11a2, a series connection and a parallel connection will be performed as described below. More specifically, in the parallel connection, the coils 11a1 and 11a2, as shown in FIG. 8A, the terminal P11 and the terminal P21 are connected to the terminal CON 11, and the terminals P12 and P22 are connected to the terminal CON12. In the series connection, the coils 11a1 and 11a2, as shown in FIG. 8B, the terminal P11 is connected to the terminal CON21, the terminal P12 is connected to the terminal P21, and the terminal P22 is connected to the terminal CON22.

In the communication device 1, as the terminal structure of the terminal unit 11b, a 4-terminal structure including the terminals P11, P12, P21, and P22 is employed to electrically connect the coils 11a1 and 11a2 to each other. Furthermore, as a connection state, any one of the series connection and the parallel connection is selected and can be performed to make it possible to select an inductance of the antenna coil 11a in two steps depending on signal amplifying characteristics or the like of the communication processing unit 12 connected to the antenna coil 11a.

As described above, the communication device 1, as shown in FIGS. 7B and 7C, the coil 11a2 has the antenna coil 11a having a structure arranged to be closer to the central part 132a of the circuit board 132 than the coil 11a1.

In this case, under the condition in which the outer shape and the number of turns of the antenna coil 11a regulated on an x-y plane of the circuit board 132 are constant, the performances of the antenna coil 11a of the communication device 1 and the antenna coil 211a of the communication device 201 according to the comparative example are evaluated.

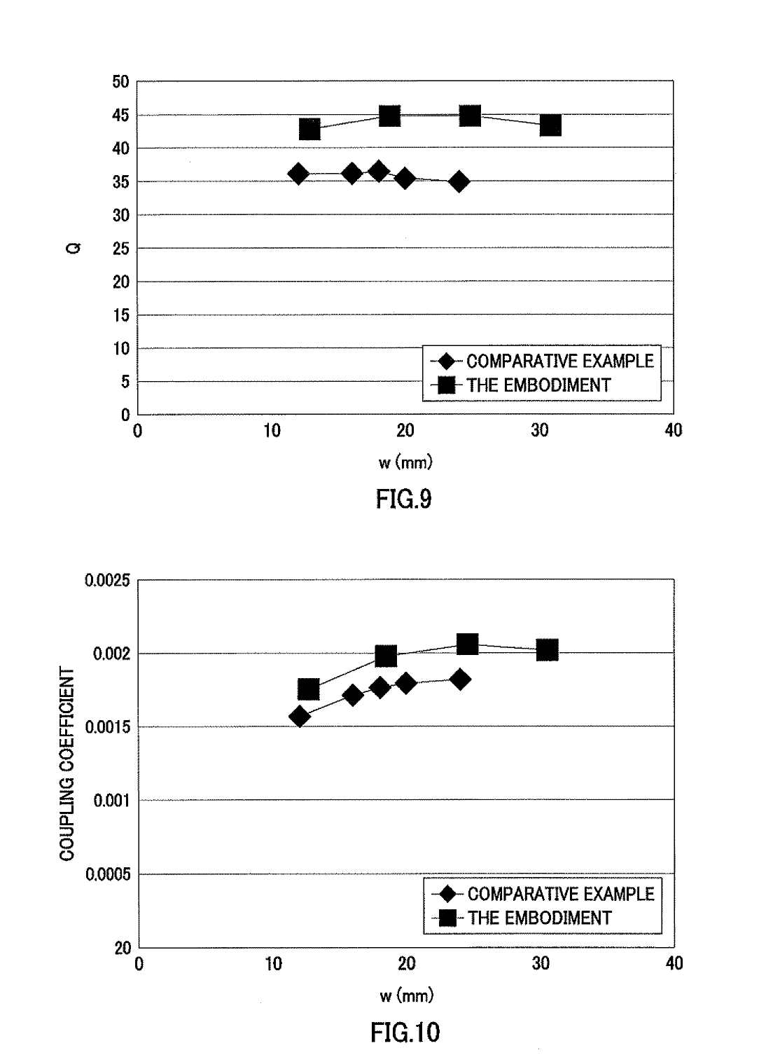

FIG. 9 is a graph showing a change in Q value of the antenna coil when a width W of the antenna coil 11a. FIG. 10 is a graph showing a change in coupling coefficient between the antenna coil 11a and the antenna 121 of the reader-writer 120 when the width W of the antenna coil.

As is apparent from the results in FIGS. 9 and 10, in comparison with the communication device 201 according to the comparative example, in the communication device 1, the line width of the coil can be averagely widened, and a resistance can be reduced. For this reason, the Q value can be made high, and the coupling coefficient can be made high. As a result, the communication characteristics can be improved.

In the communication device 1 having the above configuration, the magnetic sheet 13 is arranged such that a part of the conductive line of the coil 11a2 in which the magnetic sheet 13 is arranged on the circuit board 132 side and a part of the conductive line of the coil 11a1 arranged to be closer to the circuit board 132 side than the magnetic sheet 13 are superimposed in a direction orthogonal to the circuit board 132. In this manner, the number of turns can be increased without narrowing the line width of the conductive line. Thus, in the communication device 1, since the number of turns of the antenna coil 11a can be increased while suppressing an increase in resistance depending on the line width of the conductive line and an increase in coil area in the planar direction of the circuit board 132, improved communication characteristics can be realized.

In the communication device 1, at least, a part of the conductive line of the coil 11a2 and a part of the conductive line of the coil 11a1 need only be arranged to be superimposed in the direction orthogonal to the circuit board 132. For example, as shown in FIG. 7C, the coils 11a1 and 11a2 are very preferably inserted into the magnetic sheet 13 such that half regions of the outer shapes regulated in the planar direction of the circuit board 132 are superimposed on each other. More specifically, in the communication device 1, a part of the conductive line of the coil 11a2 in which the magnetic sheet 13 is arranged on the circuit board 132 side and a part of the conductive line of the coil 11a1 arranged to be closer to the circuit board 132 side than the magnetic sheet 13 are preferably superimposed on each other through the magnetic sheet 13 in terms of communication characteristics.

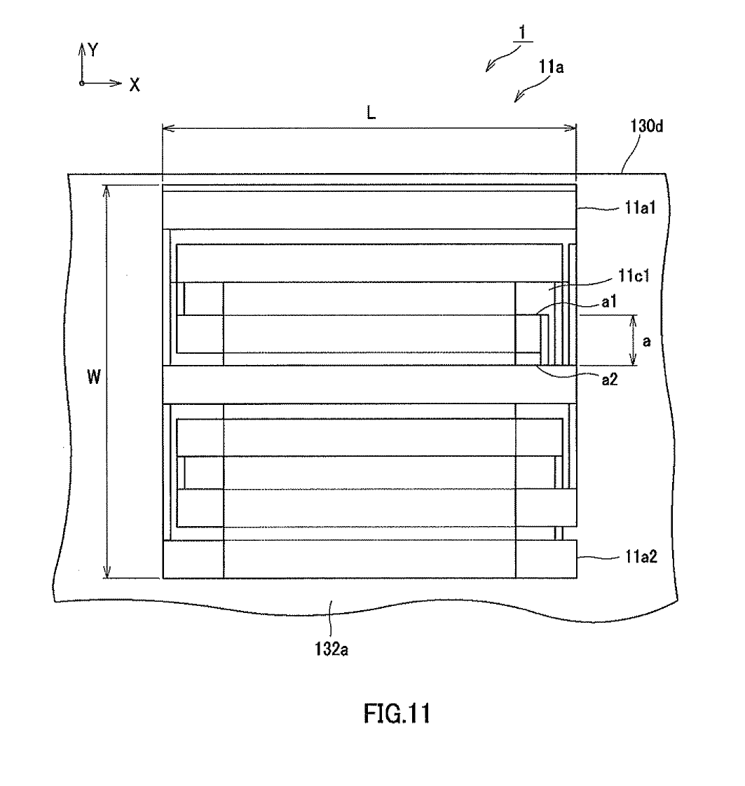

In this case, as shown in FIG. 11, the outer shape of the antenna coil 11a regulated by the width W and the length L are set to be constant, i.e., 20 mm and 20 mm, respectively. As will be described below, a superimposing position between the coils 11a1 and 11a2 is expressed with a value a [mm] regulated in a direction of the width W. More specifically, when an end side a1 on the central part 132a side of the opening 11c1 of the coil 11a1 is used as an origin in a y-axis direction, a position of an end side a2 on the outer peripheral side 130d side of the coil 11a2 is defined as a [mm].

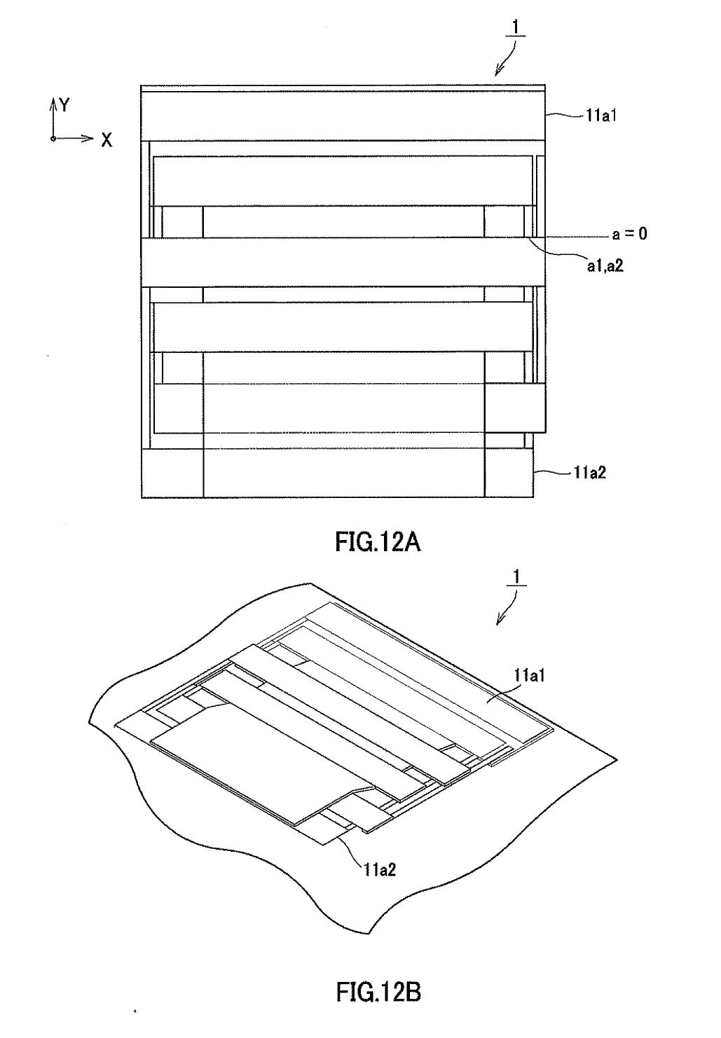

In this case, FIGS. 12A and 12B are a plan view and a perspective view showing the coils 11a1 and 11a2 that are inserted into the magnetic sheet 13 such that, when a=0 [mm], almost ½ regions of the coils 11a1 and 11a2 are superimposed on each other.

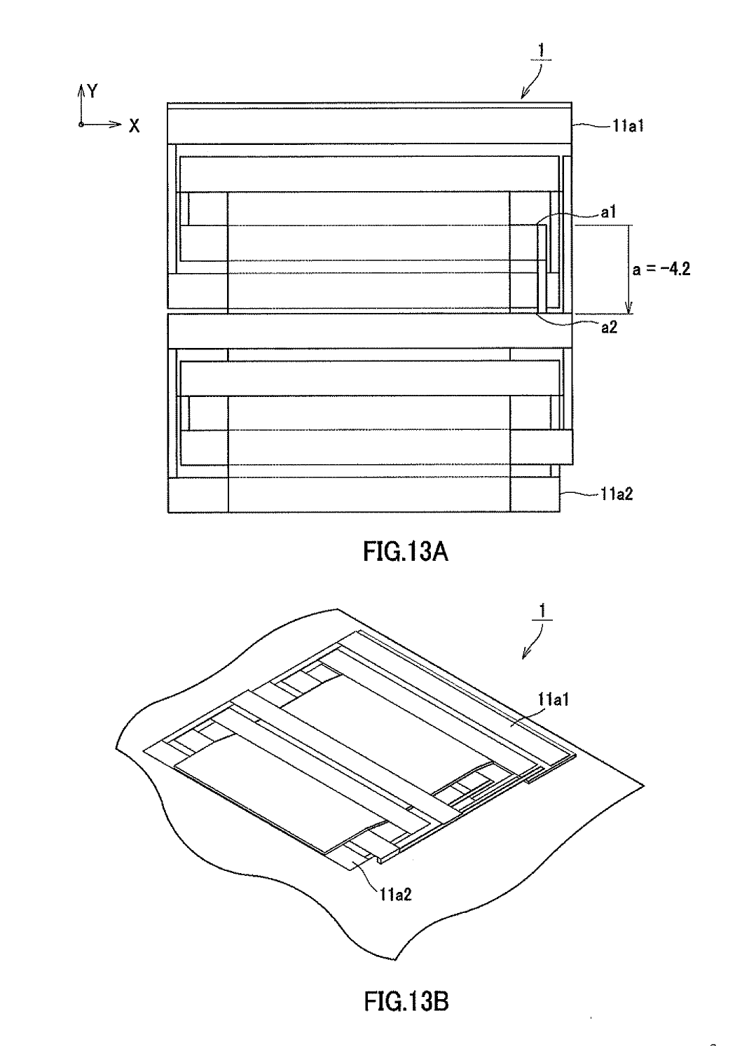

FIGS. 13A and 13B are a plan view and a perspective view showing the coils 11a1 and 11a2 that are inserted into the magnetic sheet 13 such that, when a=−4.2 [mm], almost ¼ regions of the coils 11a1 and 11a2 are superimposed on each other.

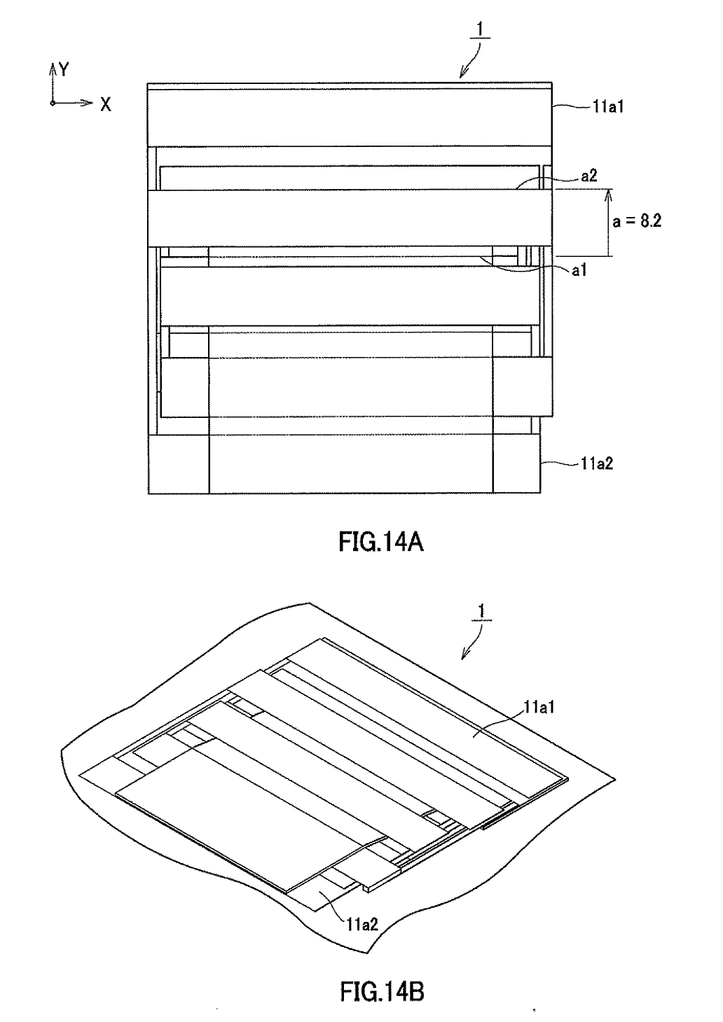

FIGS. 14A and 14B are a plan view and a perspective view showing the coils 11a1 and 11a2 that are inserted into the magnetic sheet 13 such that, when a=8.2 [mm], almost ¾ regions of the coils 11a1 and 11a2 are superimposed on each other.

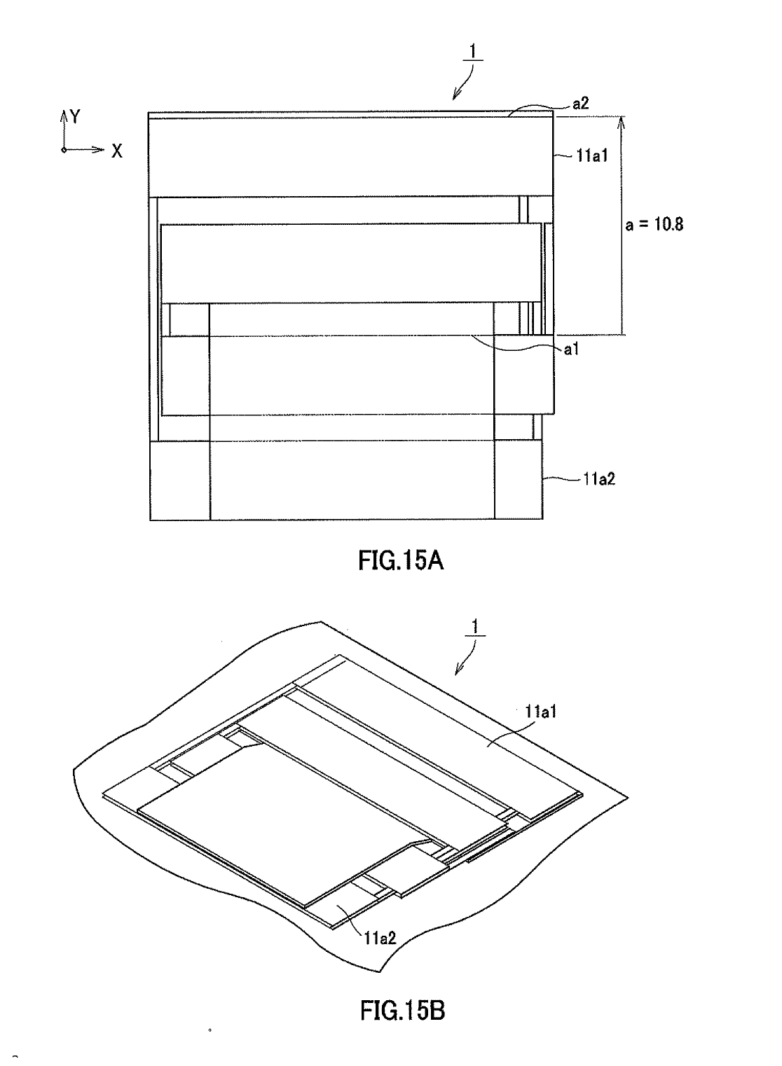

FIGS. 15A and 15B are a plan view and a perspective view showing the coils 11a1 and 11a2 that are inserted into the magnetic sheet 13 such that, when a=10.8 [mm], the coils 11a1 and 11a2 are almost completely superimposed on each other to coincide with each other.

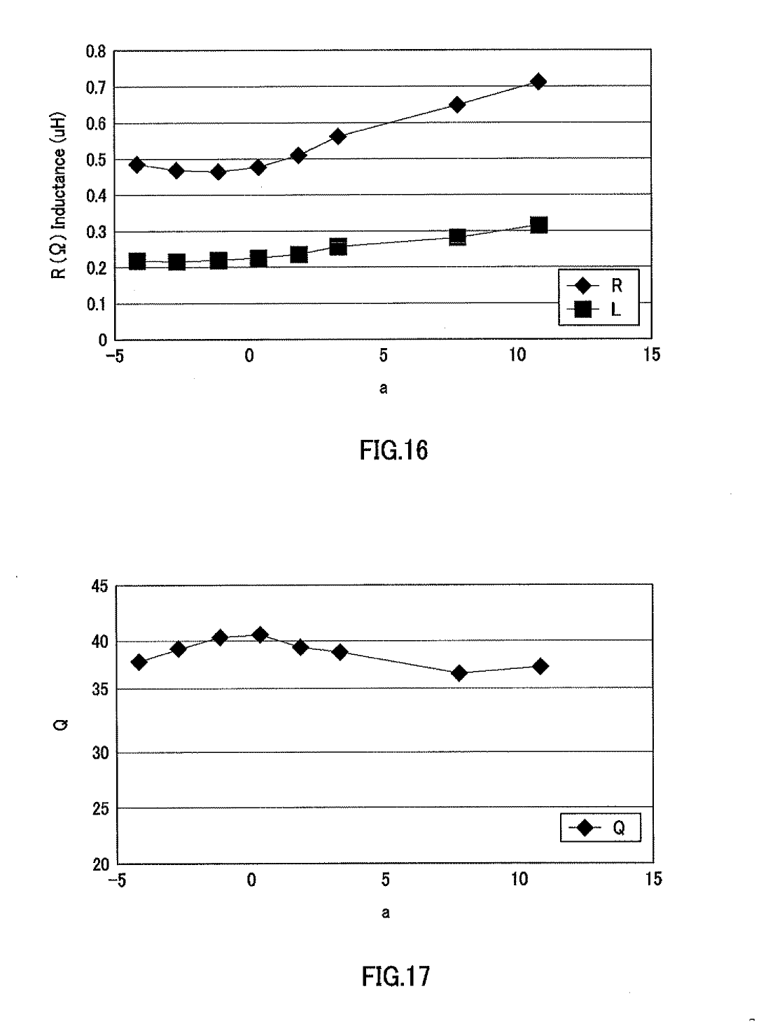

FIG. 16 shows a change of a resistance R and a change of a inductance L when superimposing states between the coils 11a1 and 11a2 are changed by changing a value a [mm].

As is apparent from FIG. 16, when the value a becomes positive, i.e., when superimposed regions of the outer shapes of the coils 11a1 and 11a2 are larger than the almost ½ regions, the inductance L is almost constant, but the resistance increases.

When the superimposed regions of the outer shapes of the coils 11a1 and 11a2 are larger than the almost ½ regions, a part of the conductive line of the coil 11a2 in which the magnetic sheet 13 is arranged on the circuit board 132 side and a part of the conductive line of the coil 11a1 arranged to be closer to the circuit board 132 side than the magnetic sheet 13 are superimposed on each other without through the magnetic sheet 13. For this reason, since a current is difficult to flow due to a proximity effect between the conductive lines, the resistance increases.

In contrast to this, when a part of the conductive line of the coil 11a2 in which the magnetic sheet 13 is arranged on the circuit board 132 side and a part of the conductive line of the coil 11a1 arranged to be closer to the circuit board 132 side than the magnetic sheet 13 are superimposed through the magnetic sheet 13, the action that makes the flow of current difficult does not occur. This is because an electromagnetic waves generated by the conductive lines are absorbed by the magnetic sheet 13.

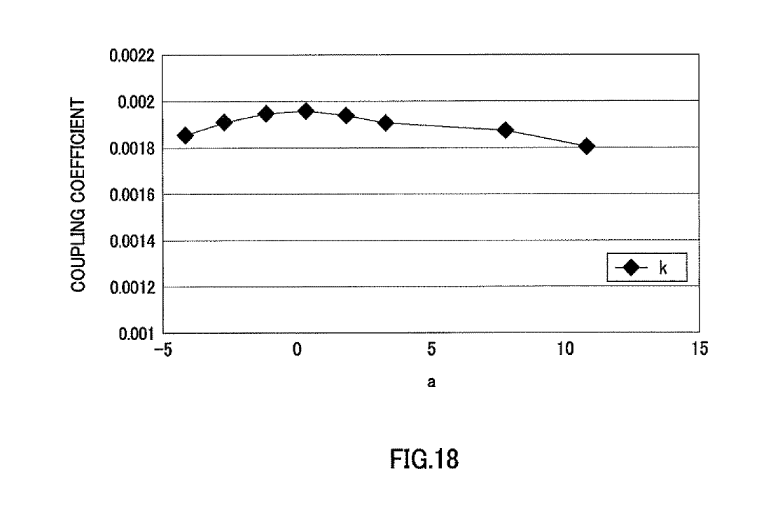

FIGS. 17 and 18 show a change in Q value and a change of a coupling coefficient k between the reader-writer 120 and the antenna 121 when the superimposing states between the coils 11a1 and 11a2 are changed by changing the value a [mm], respectively.

As is apparent from FIG. 16 to FIG. 18, regions that are smaller than the almost ½ regions of the coils 11a1 and 11a2 are preferably superimposed on each other in terms of communication characteristics.

In other words, in the communication device 1, a part of the conductive line of the coil 11a2 in which the magnetic sheet 13 is arranged on the circuit board 132 side and a part of the conductive line of the coil 11a1 arranged to be closer to the circuit board 132 side than the magnetic sheet 13 are superimposed through the magnetic sheet 13 to reduce a resistance and to realize a high Q value. For this reason, the communication device 1 is preferable in terms of communication characteristics. In particular, in terms of a reduction of an outer shape while realizing a high Q value, the coils 11a1 and 11a2 are preferably inserted into the magnetic sheet 13 such that a=0 [mm] is satisfied, i.e., almost ½ regions of the coils 11a1 and 11a2 are superimposed on each other.

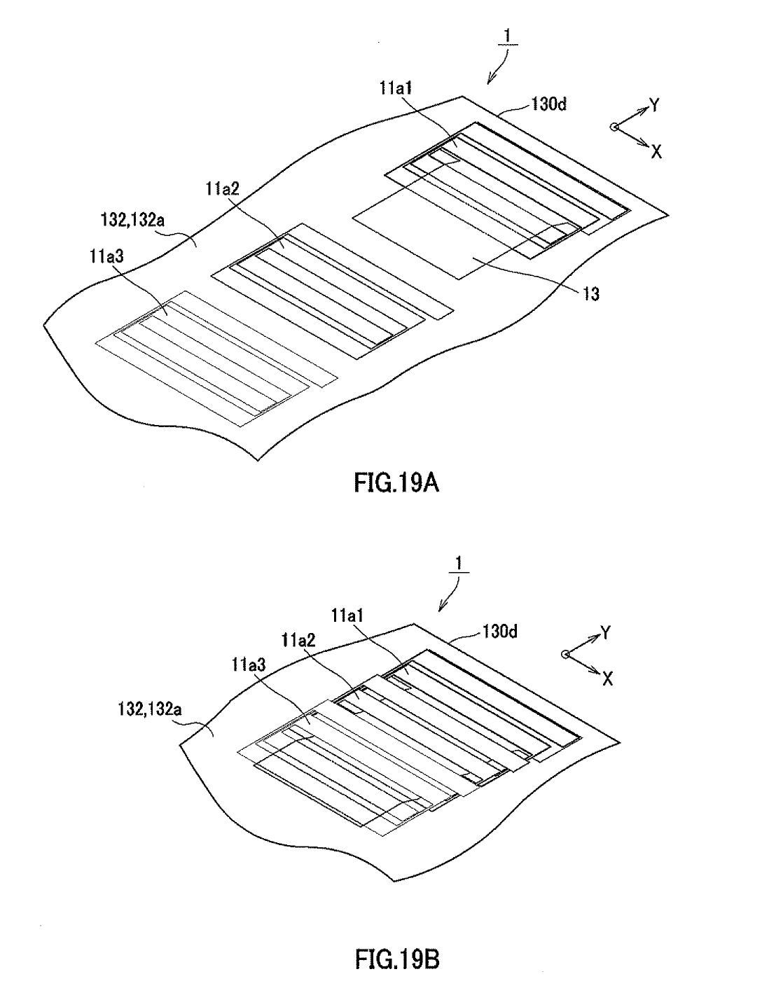

In the communication device 1 according to the first embodiment, although the two coils 11a1 and 11a2 are used, two or more coils may be used. For example, as shown in FIGS. 19A and 19B, three coils 11a1, 11a2, and 11a3 may be inserted into the magnetic sheet 13. In this manner, improved communication characteristics can be realized by an increase in inductance by increasing the number of turns while suppressing the resistance from increasing as much as possible.

### Second Embodiment

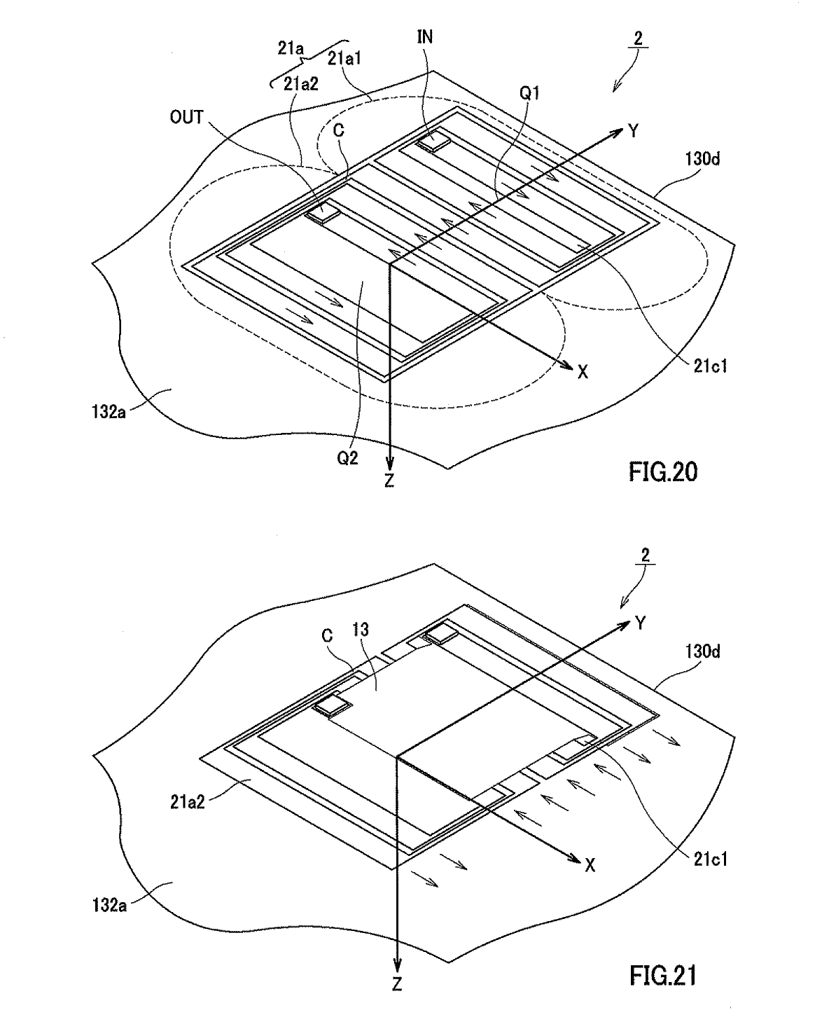

A configuration of a communication device according to the second embodiment will be concretely described below with reference to FIGS. 20 to 23.

A communication device 2 according to the second embodiment, for example, as shown in FIG. 20, is formed on an antenna circuit board 21 configured by one printed-circuit board, and has an antenna coil 21a in which two coils 21a1 and 21a2 winded in opposite directions are connected to each other by a contact point C. In this case, to wind the coils 21a1 and 21a2 the opposite directions, more specifically, as shown in FIG. 20, is that, when a current is caused to flow from an input terminal IN of the coil 21a1 to an output terminal OUT of the coil 21a2 through the contact point C, a direction of a current in the coil 21a1 having a center Q1 and a direction of a current in the coil 21a2 having a center Q2 are opposite to each other. Central points of the coils 21a1 and 21a2 are defined as cores Q1 and Q2, respectively.

In the communication device 2 having the antenna coil 21a, first, as shown in FIG. 21, the coil 21a1 is arranged to be closer to the outer peripheral side 130d of the circuit board 132 than the coil 21a2. On the central part 132a side of the circuit board 132, an opening 21c1 of the coil 21a1 is inserted into the magnetic sheet 13. The coil 21a1 is arranged to be closer than the circuit board 132 than the magnetic sheet 13. On the outer peripheral side 130d side of the circuit board 132, the magnetic sheet 13 is arranged to be closer to the circuit board 132 than the coil 21a1.

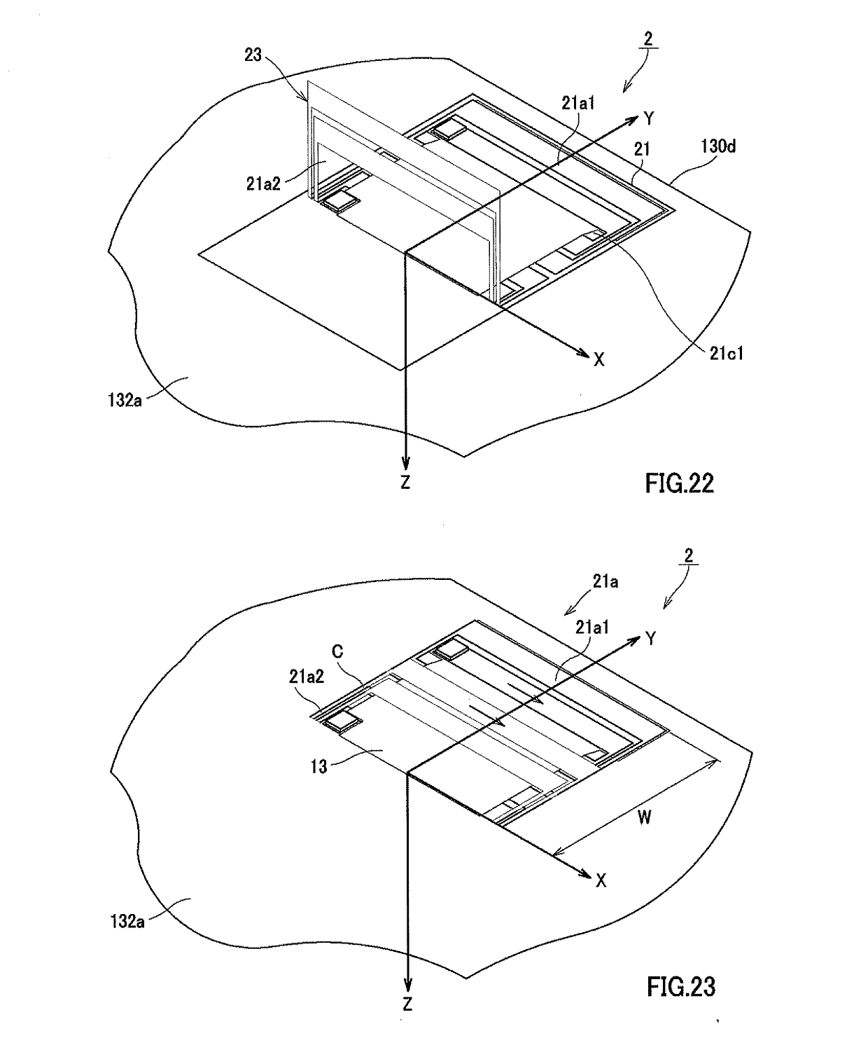

In the communication device 2, as shown in FIG. 21, a magnetic sheet is inserted into the opening 21c1 of the coil 21a1. As shown in FIG. 22, of the coil 21a2, with reference to an opening 21c2 of the coil 21a2, a conductive line part 23 located on the central part 132a of the circuit board 132 is folded in a y-axis direction, i.e., on the outer peripheral side 130d side of the circuit board 132. By the folding, in the communication device 2, as shown in FIG. 23, the conductive line part 23 located on the central part 132a side of the circuit board 132 and the conductive line of the coil 21a1 are superimposed in a direction orthogonal to the circuit board 132.

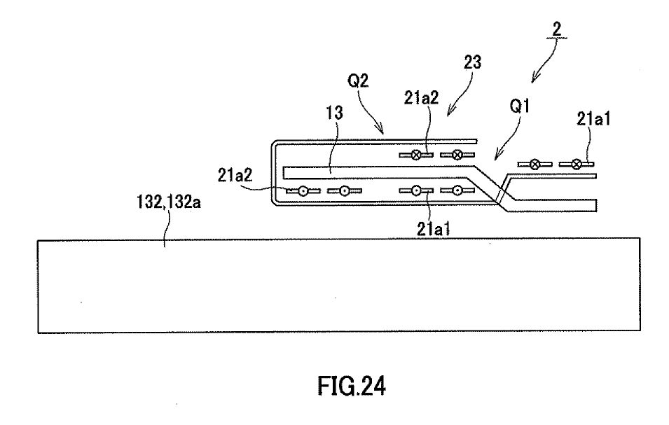

In this manner, in the communication device 2, as shown in FIG. 24, the coil 21a2 is folded to cause the winding directions of the coil 21a2 and the coil 21a1 to be identical with each other. A part of the conductive line in which the magnetic sheet 13 is arranged on the circuit board 132 side and a part of the conductive line of the coil 21a1 arranged to be closer to the circuit board 132 side than the magnetic sheet 13 are superimposed through the magnetic sheet 13.

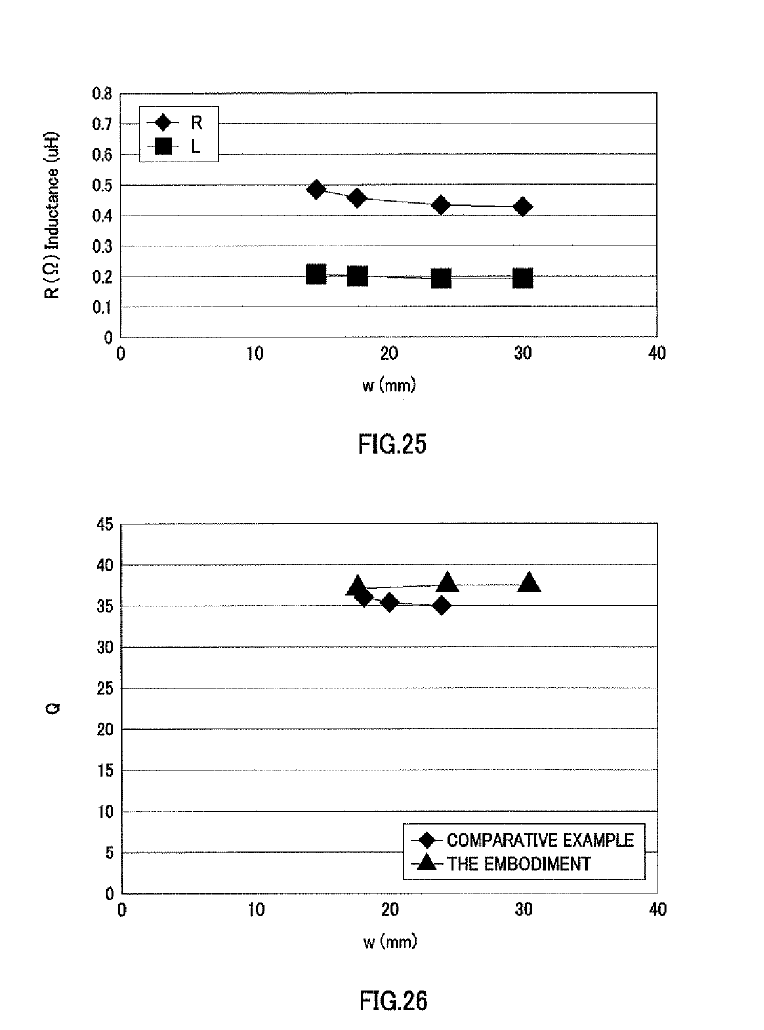

In this case, a characteristic change obtained when a width W of the antenna coil 21a regulated in a y-axis direction of the circuit board 132 will be described with reference to FIG. 25.

FIG. 25 is a diagram showing a resistance R and an inductance L obtained when the width W of the antenna coil 21a regulated in the y-axis direction of the circuit board 132. As is apparent from FIG. 25, the characteristics of the antenna coil 21a rarely change depending on the width W.

Under the condition in which an outer shape and the number of turns of the antenna coil 21a regulated on an x-y plane of the circuit board 132 are constant, performances of the antenna coil 21a of the communication device 2 and the antenna coil 211a of the communication device 201 according to the comparative example will be evaluated.

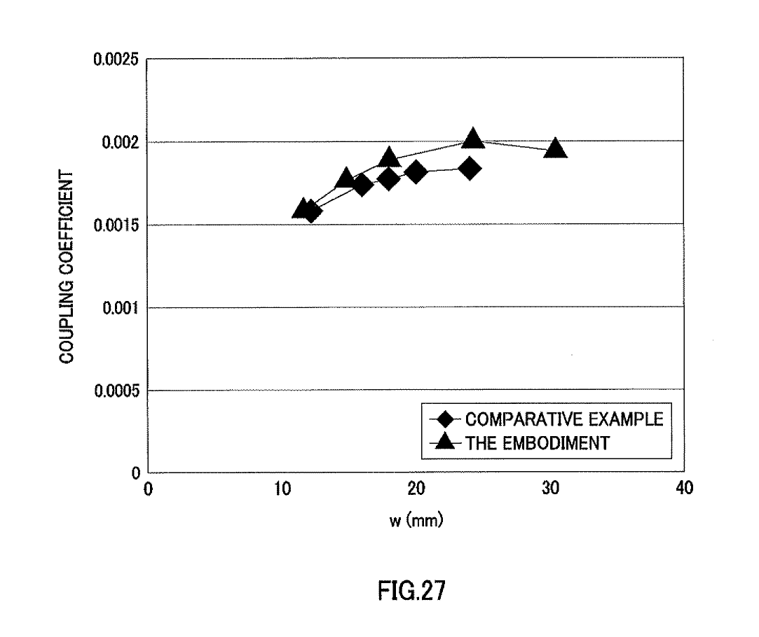

FIG. 26 is a graph showing changes in Q value of the antenna coils 21a and 211a obtained when the width W of the antenna coil regulated in the y-axis direction of the circuit board 132. FIG. 27 is a graph showing a change of a coupling coefficient k between the reader-writer 120 and the antenna 121 obtained when the width W of the antenna coils 21a and 211a regulated in the y-axis direction of the circuit board 132.

As is apparent from the results in FIGS. 26 and 27, in comparison with the communication device 201 according to the comparative example, in the communication device 2, the line width of the coil can be averagely widened, and a resistance can be reduced. For this reason, the Q value can be made high, and the coupling coefficient can be made high. As a result, the communication characteristics can be improved.

In the communication device 2 having the above configuration, the magnetic sheet 13 is arranged such that a part of the conductive line of the coil 21a2 in which the magnetic sheet 13 is arranged on the circuit board 132 side and a part of the conductive line of the coil 21a1 arranged to be closer to the circuit board 132 side than the magnetic sheet 13 are superimposed in a direction orthogonal to the circuit board 132. In this manner, the number of turns can be increased without narrowing the line width of the conductive line. In particular, in the communication device 2, the above superimposing structure can be realized by using the two coils 21a1 and 21a1 that are formed on the antenna circuit board 21 configured by one printed-circuit board and winded in opposite directions through the contact point C. For this reason, the communication device 2 can is preferable because the antenna coil can be more easily formed than the antenna coil 11a of the communication device 1 according to the first embodiment. In this manner, in the second embodiment, since the number of turns of the antenna coil 21a can be increased while suppressing an increase in resistance depending on the line width of the conductive line and an increase in coil area in the planar direction of the circuit board 132, improved communication characteristics can be realized.

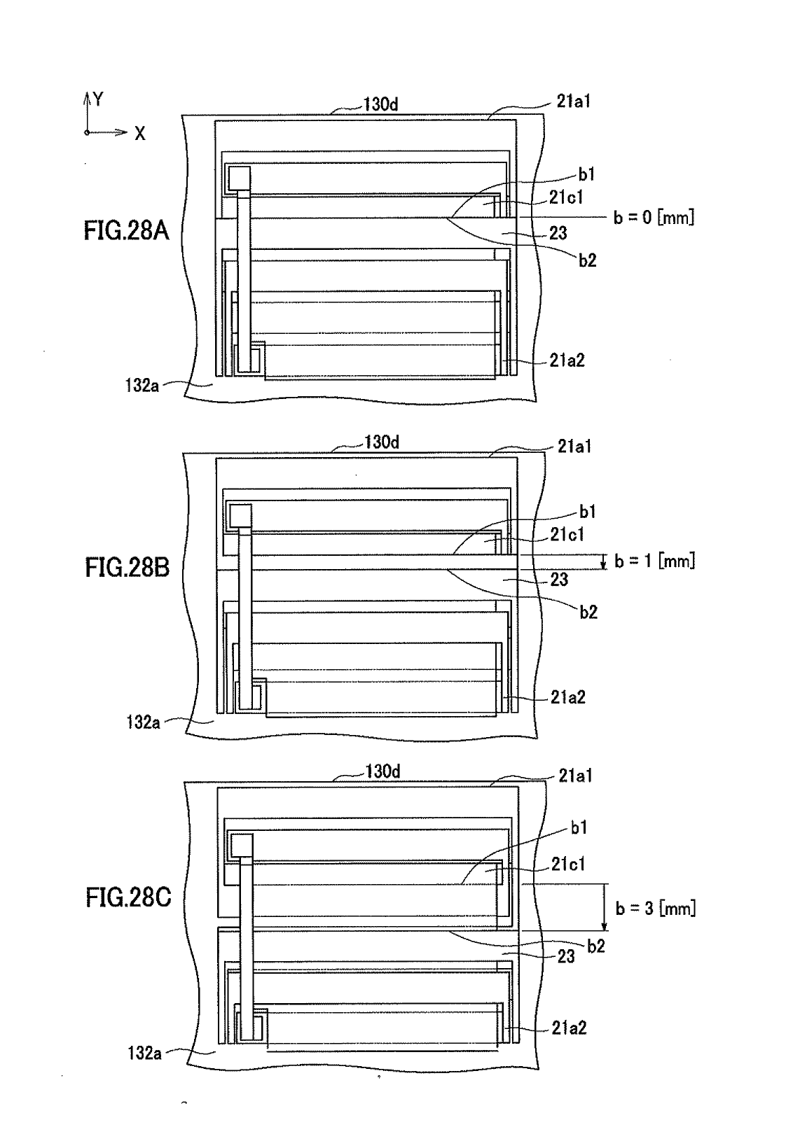

In the communication device 2, a part of the conductive line of the coil 21a2 in which the magnetic sheet 13 is arranged on the circuit board 132 side and a part of the conductive line of the coil 21a1 that is arranged to be closer to the circuit board 132 side than the magnetic sheet 13 and folded need only be arranged to be superimposed in a direction orthogonal to the circuit board 132. In particular, for example, as shown in FIG. 28A, the coil 21a1 and the folded coil 21a2 are preferably arranged such that half regions of the outer shapes regulated in the planar direction of the circuit board 132 are superimposed on each other.

In this case, as shown in FIG. 28, the outer shape of the antenna coil 21a regulated by the width W an the length L are set to be constant, i.e., 20 mm and 20 mm, respectively. As will be described below, a superimposing position between the coils 21a1 and 21a2 is expressed with a value b [mm] regulated in a direction regulated by a W direction. More specifically, in the opening 21c1 of the coil 21a1, a length b from an end side b1 on the central part 132a side to an end side b2 of the conductive line part 23 of the coil 21a2 is defined as b [mm].

FIG. 28A shows that the value b is 0 [mm] and the end side b1 and the end side b2 are identical with each other in a direction of thickness. In other words, this state is a state in which half regions of the coils are superimposed on each other in a shape in which the coil 21a1 and the coil 21a2 obtained in the folding are regulated in the planar direction of the circuit board 132.

FIG. 28B shows a state in which, when the value b is 1 [mm], ¼ regions of the coil 21a1 and the coil 21a2 obtained in the folding are superimposed on each other in a direction orthogonal to the circuit board 132.

Furthermore, FIG. 28C shows a state in which, when the value b is 3 [mm] the coil 21a1 and the coil 21a2 obtained in the folding are superimposed in a direction orthogonal to the circuit board 132. In other words, ¼ regions of the coil 21a1 and the coil 21a2 obtained in the folding are superimposed on each other in a shape regulated in a planar direction of the circuit board 132.

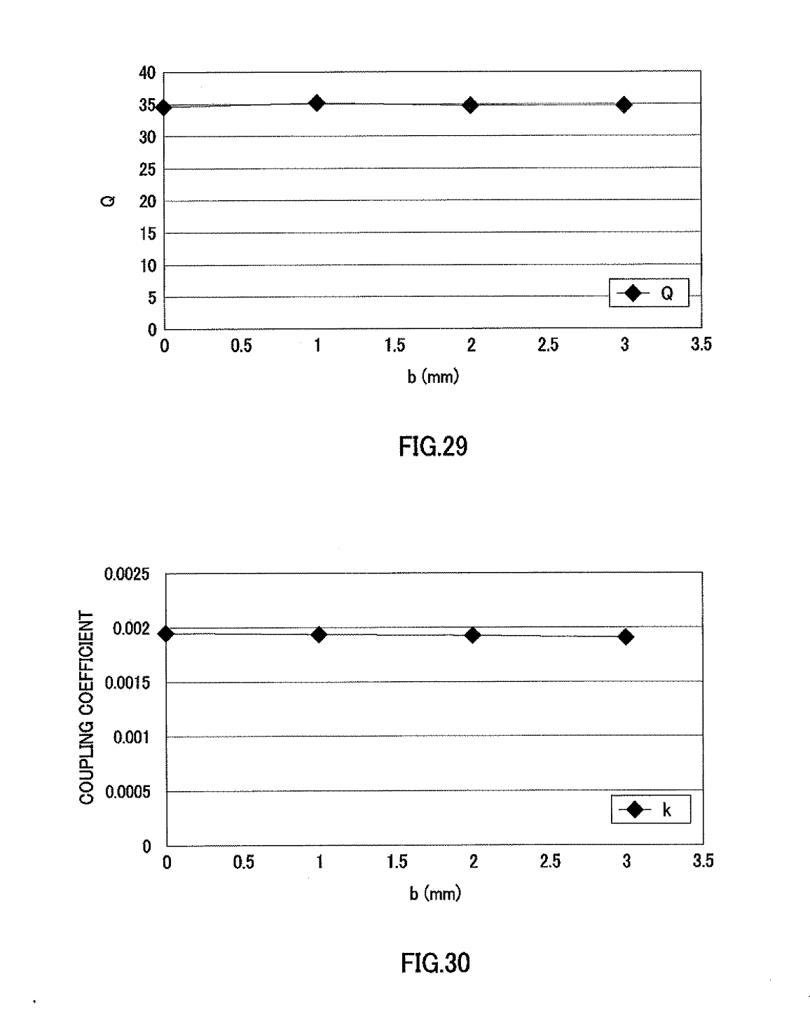

FIGS. 29 and 30 show a change in Q value and a coupling coefficient k between the reader-writer 120 and the antenna 121 when a superimposing state between the coils 21a1 and 21a2 is changed by changing the value b [mm], respectively.

According to the results in FIGS. 29 and 30, when the superimposed regions of the outer shapes of the coils 21a1 and 21a2 are almost ½ or less, the communication characteristics rarely change.

### <Modification of Second Embodiment>

As a request of an electronic device on which the antenna module according to the present invention is mounted, a reduction in size or thickness is generally given. However, when a thin magnetic sheet is used to cope with the reduction in thickness, desired magnetic characteristics may not be sufficiently exerted. In such a case, a magnetic sheet having a certain thickness must be used. However, in the configuration of the antenna module, when the thick magnetic sheet, an antenna circuit board must be largely folded, and the magnetic sheet must be inserted into an opening of the antenna circuit board. For this reason, the antenna module cannot be easily manufactured, and has poor mass productivity. The magnetic sheet includes a film-like base material on which a magnetic powder is applied and a magnetic sheet that is shaped into a plate-like sheet having a certain thickness by using, for example, a calcimining technique or the like.

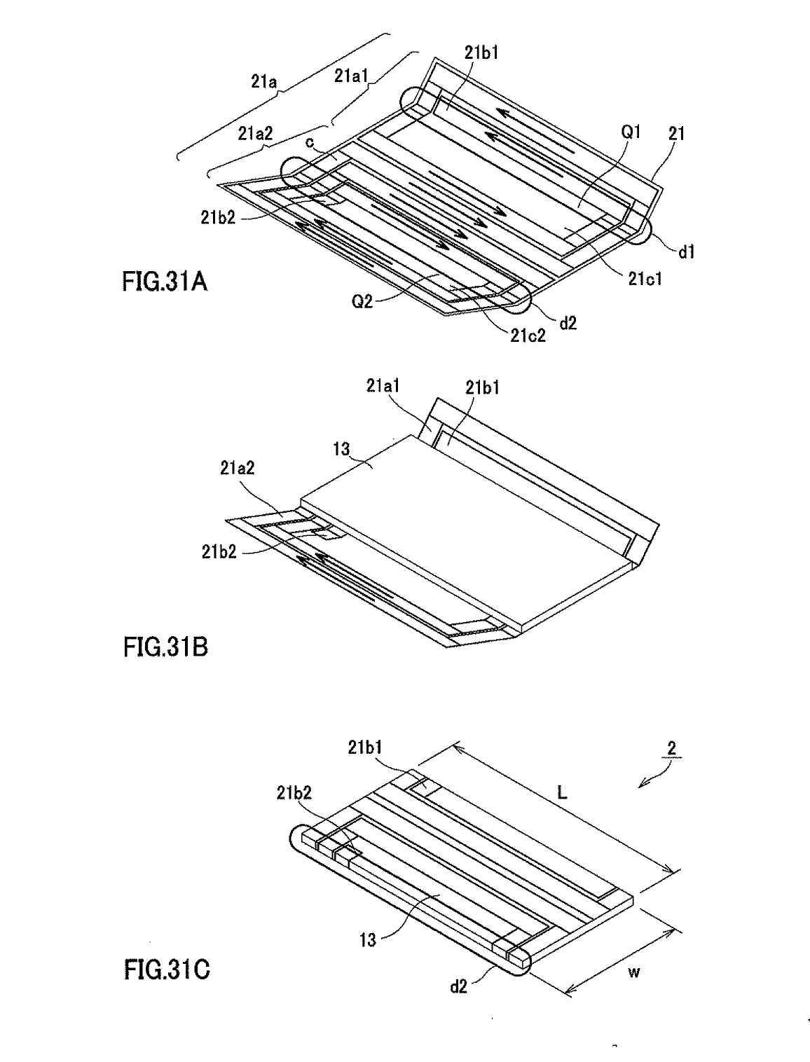

Thus, as shown in FIGS. 31A to 31C, a conductive line is formed on a flexible antenna circuit board such as a flexible printed-circuit board, and the antenna coil 21a obtained by connecting the coils 21a1 and 21a2 winded in opposite directions to the contact point C is used. The opening 21c1 is formed in the coil 21a1, and the center of the coil is a core Q1. Similarly, the opening 21c2 is formed in the coil 21a2, and the center of the coil is a core Q2. An open end of the conductive line of the coil 21a1 serves as a terminal 21b1, and an open end of the conductive line of the coil serves as a terminal 21b2. An arrow written in the conductive line indicates a direction of current at a certain instant. In this case, as shown in FIG. 31A, on the antenna circuit board 21, depending on the thickness of the magnetic sheet 13 when the magnetic sheet 13 is mounted, a bent part d1 of the coil 21a1 and a bent part d2 of the coil 21a2 are formed. The bent part d1 is arranged to have a length corresponding to the thickness of the magnetic sheet 13 from an edge on the outer peripheral side 130d side of the opening 21c2 of the coil 21a2 along the antenna circuit board 21. To wind the coils in opposite directions, as in the case in FIG. 20, is that, when a current is caused to flow from the terminal 21b1 serving as the input terminal of the coil 21a1 to the terminal 21b2 serving as an output terminal through the contact point C, a direction of current in the coil 21a1 having the core Q1 as its center is opposite to a direction of current flowing around the core Q2. In FIGS. 31B and 31C, in order to more clearly show the state of the antenna coil 21a, the antenna circuit board 21 is omitted.

The following configuration is formed by using the above antenna circuit board and the above magnetic sheet 13 to assemble the communication device 2.

As shown in FIG. 31B, the magnetic sheet 13 is mounted on the antenna coil 21a including the coils 21a1 and 21a2. A position where the magnetic sheet 13 is mounted is set to a position where one end side of the magnetic sheet 13 is brought into contact with the bent part d1. The magnetic sheet 13 is mounted such that the other end side of the magnetic sheet 13 is brought into contact with the bent part d2.

As shown in FIG. 31C, an end of the coil 21a1 on the outer peripheral side 130d side and an end of the coil 21a2 on the central part 132a side are folded along the bent parts d1 and d2, and the antenna circuit board 21 is folded to cover the upper surface of the magnetic sheet 13 so as to complete the communication device 2.

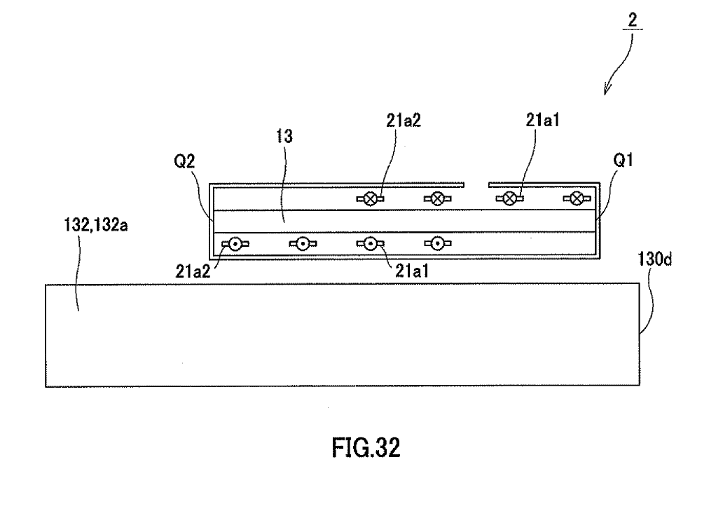

As shown in FIG. 32, in the communication device 2, the conductive line at an edge of the folded coil 21a1 is located to be closer to the reader-writer 120 than the magnetic sheet 13 on the outer peripheral side 130d side. On the central part 132a side of the circuit board 132, the magnetic sheet 13 is located to be closer to the reader-writer 120 than the conductive line of the coil 21a2. In this case, the conductive line on at an edge of the folded coil 21a2 is superimposed on the conductive line on the circuit board 132 side of the coil 21a1, and half regions of the conductive line on the reader-writer 120 side and the conductive line of the circuit board 132 side are preferably superimposed on each other in the planar direction of the circuit board 132.

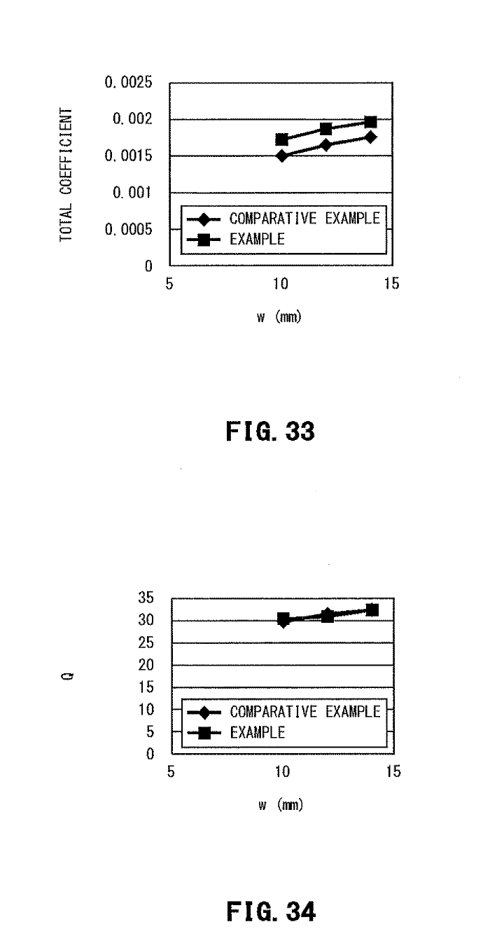

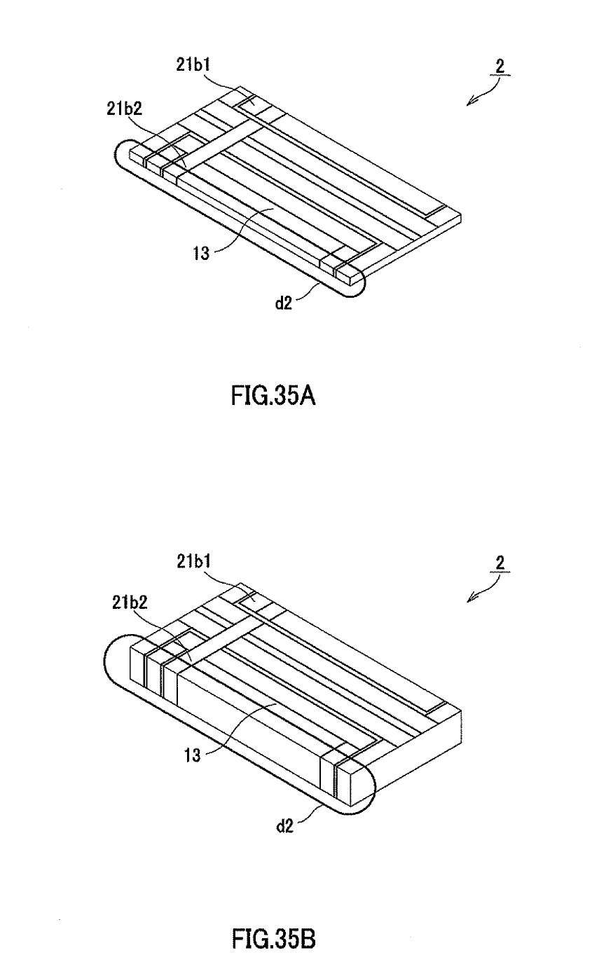

FIGS. 33 and 34 show results obtained by evaluating communication characteristics of the communication device 2 when the width W of the communication device in FIG. 31C is changed. FIG. 33 shows a change in coupling coefficient for the width W of the communication device 2 in comparison with the communication device 201 according to the comparative example. It is understood that, even though the width W is arbitrarily set, preferable coupling coefficients can be obtained in comparison with the communication device 201 according to the comparative example. FIG. 34 shows a change in Q value for the width W in comparison with the communication device 201 according to the comparative example. It is shown that the Q value is constant even though the width W is arbitrarily set. As a result, the communication device 2 can obtain communication characteristics that are better than those of the communication device 201.

As shown in FIG. 35A, the bent parts d1 and d2 are appropriately set to make it possible to use a magnetic sheet having a larger thickness, for example, a thickness of 1 mm. As shown in FIG. 35B, when the bent parts d1 and d2 are further enlarged, a magnetic sheet having a further larger thickness, for example, a thickness of 3 mm.

In the modification, when the antenna circuit board 21 on which the conductive line of the antenna coil 21a is arranged is folded depending on the thickness of the magnetic sheet 13, the antenna circuit board 21 need not be bent to have a curved surface. For this reason, on the printed-circuit board, notches or the like are formed in bent portions of the bent parts d1 and d2 to make it possible to use not only a flexible printed-circuit board but also a rigid circuit board. Since the bent parts d1 and d2 can be used to position the magnetic sheet 13, automation can be employed to make manufacturing steps easy. When the size of the antenna circuit board 21 is set to be larger than that of the magnetic sheet 13, the magnetic sheet 13 can be completely enwrapped with the antenna circuit board 21. As a material of the antenna circuit board 21, a flexible plastic material such as polyimide and PET is used to make it possible to seal the magnetic sheet 13 inside the antenna circuit board 21. In particular, when a ceramic material such as ferrite is used as a magnetic material, ceramic powder can be prevented from falling when the communication device 2 according to the present invention is mounted in an electronic device.

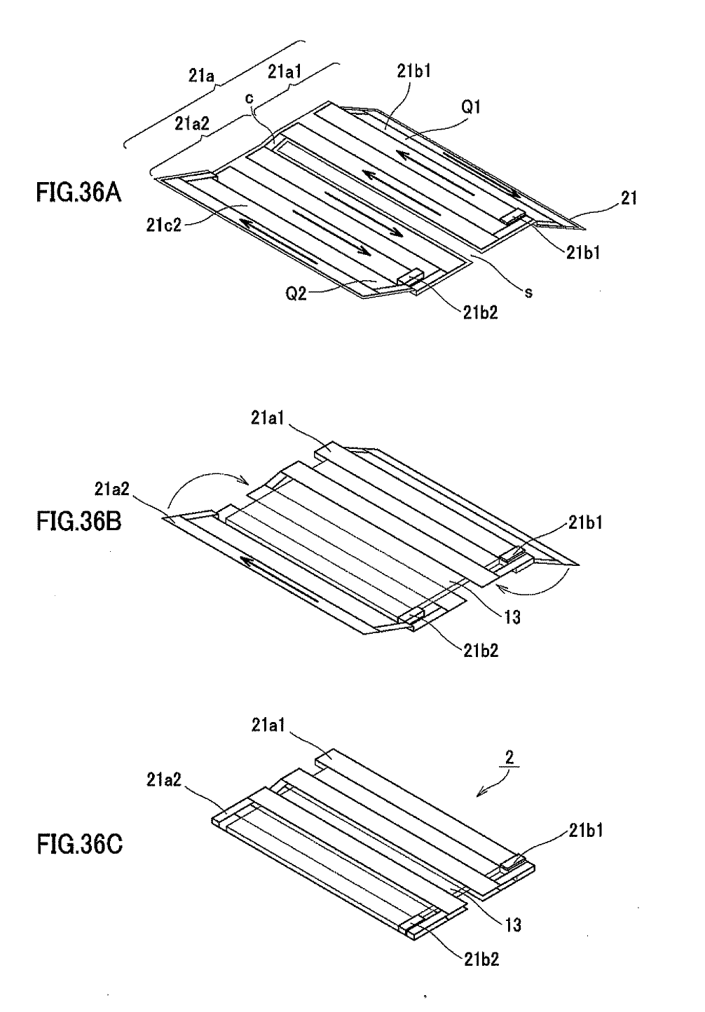

Furthermore, as another modification, as shown in FIG. 36, a conductive line configuring the antenna coil 21a is formed on the antenna circuit board 21, and the coils 21a1 and 21a2 winded in opposite directions are connected to the contact point C to form the communication device. A slit s into which the magnetic sheet is inserted is formed between the coils 21a1 and 21a2. In the configuration as shown in FIG. 31, the communication device is configured such that both the ends of the antenna circuit board 21 are folded back in the same direction to enwrap a magnetic material. In contrast to this, the configuration is different from that in the embodiment in that, as shown in FIG. 36B, both the ends of the antenna circuit board 21 are folded back in vertically opposite direction to configure the communication device 2. In FIGS. 36B and 36C (will be described later), in order to more clearly show the state of the antenna coil 21a, the antenna circuit board 21 is omitted.

As shown in FIG. 36, the coil 21a1 is mounted on the magnetic sheet 13 to cover an almost ½ region of the magnetic sheet 13, the magnetic sheet 13 is inserted into the slit, and the coil 21a2 is mounted on a lower part of the remaining ½ region of the magnetic sheet 13.

As shown in FIG. 36C, an end of the coil 21a1 is folded downward to be superimposed on the lower surface of the magnetic sheet 13 in parallel with each other. An end of the coil 21a2 is folded upward to be superimposed on the upper surface of the magnetic sheet 13 in parallel with each other.

In the modification, as the magnetic sheet, a magnetic sheet having a certain thickness may be used.

The coil 21a1 and the coil 21a2 are formed on different printed-circuit boards, respectively, and the coil 21a1 is placed on the upper surface of the magnetic sheet 13. Thereafter, an end of the coil 21a1 is folded downward, the coil 21a2 is placed on the lower surface of the magnetic sheet, and an end of the coil 21a2 is folded upward. Thereafter, the coil 21a1 and the coil 21a2 may be connected to the connection point C.

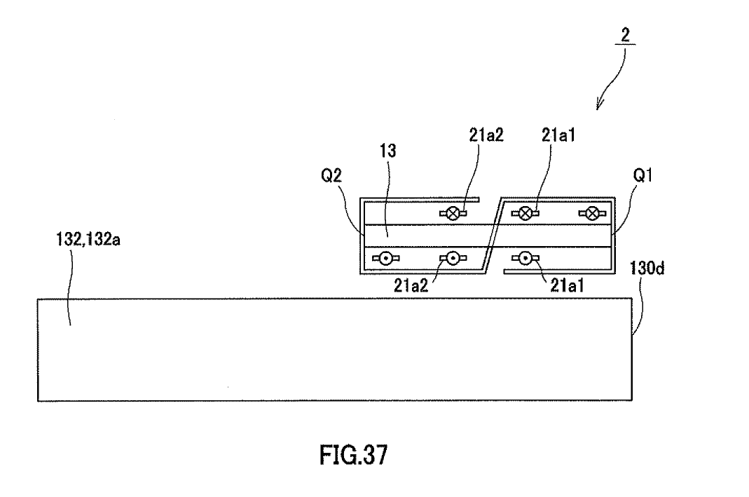

As shown in FIG. 37, in the communication device 2, a conductive line at an end of the coil 21a1 folded on the circuit board 132 side is located to be closer to the circuit board 132 than the magnetic sheet 13 on the outer peripheral side 130d side. On the central part 132a side, a conductive line at an end of the coil 21a2 folded on the reader-writer 120 side is located to be closer to the reader-writer 120 side than the magnetic sheet 13. In this case, a conductive line at an end of the folded coil 21a2 is superimposed on the conductive line on the circuit board 132 side of the coil 21a1, and the conductive line on the reader-writer 120 side and the conductive line on the circuit board 132 side are preferably arranged such that the half regions of the conductive lines are superimposed in the planar direction of the circuit board 132.

In the modification, since a conductor pattern of the antenna coil 21a obtained when the antenna circuit board 21 is developed and the folding position of the antenna circuit board 21 can be axisymmetrical about the contact point C and the slit s, pattern design and circuit board design can be easily performed. For this reason, the manufacturing step can be simplified.

### Third Embodiment

A printed-circuit board and a magnetic sheet that form an antenna coil are laminated to make it possible to simplify manufacturing steps.

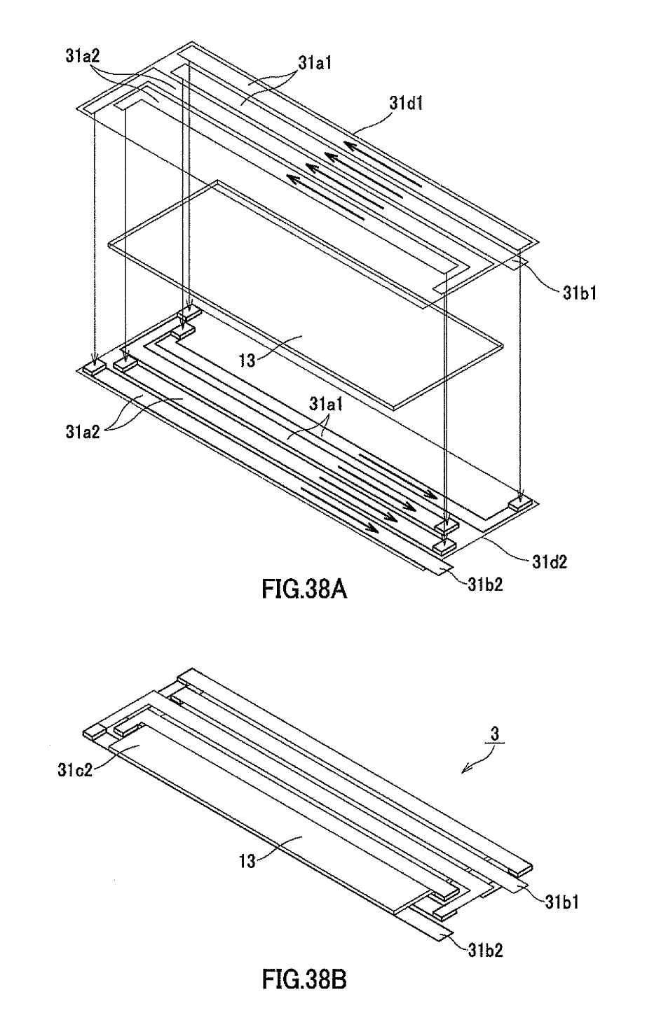

As shown in FIG. 38A, on a printed-circuit board 31d1, a part of a coil 31a1 and a part of a coil 31a2 are formed. For example, a conductive line to be arranged to be closer to the outer peripheral side 130d on a housing surface is a part of the coil 31a1, and a conductive line to be arranged to be closer to the central part 132a configures the coil 31a2. On a second printed-circuit board 31d2, a part of the coil 31a1 and a part of the coil 31a2 are formed. For example, a conductive line to be arranged to be closer to the central part 132a on the housing surface configures the coil 31a2, and a conductive line to be arranged to be closer to the outer peripheral side 130d configures the coil 31a1. Directions of currents flowing on the conductive lines configuring the coils 31a1 and 31a2, as indicated by arrows in FIG. 38A, are the same direction in the first and second printed-circuit boards 31d1 and 31d2, and the current flowing in the conductive line of the first printed-circuit board 31d1 and the current flowing in the second printed-circuit board 31d2 have opposite directions.

The magnetic sheet 13 is inserted between the first printed-circuit board 31d1 and the second printed-circuit board 31d2. More specifically, the magnetic sheet 13 is mounted on the upper surface of the positioned second printed-circuit board 31d2 such that the magnetic sheet 13 is positioned with respect to a specific position of, for example, the second printed-circuit board 31d2. Furthermore, the first printed-circuit board 31d1 is positioned and mounted on the positioned second printed-circuit board 31d2 and the upper surface of the magnetic sheet 13. Subsequently, as shown in FIG. 38B, the conductive line on the first printed-circuit board 31d1 and the conductive line on the second printed-circuit board 31d2 are electrically connected to each other to form the first and second coils 31a1 and 31a2. In FIG. 38B, in order to clearly show the states of the coils 31a1 and 31a2, the printed-circuit boards 31d1 and 31d2 are omitted.

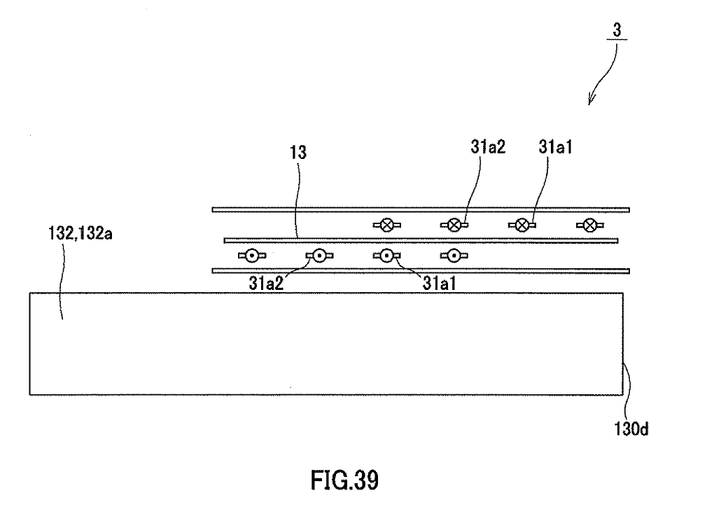

As shown in FIG. 39, on the outer peripheral side 130d side of the circuit board 132, the conductive line of the first coil 31a1 is closer to the reader-writer 120 than the magnetic sheet 13. On the central part 132a side, the conductive line of the second coil 31a2 is closer to the circuit board 132 side than the magnetic sheet 13. ½ regions of the first coil 31a1 and the second coil 31a2 can be vertically superimposed on each other. In this manner, a magnetic field from the reader-writer 120 can be efficiently attracted to the magnetic sheet 13, and the communication characteristics can be improved.

Not only a thin magnetic sheet but also a thick magnetic sheet can be used.

The areas of the first and second printed-circuit boards 31d1 and 31d2 are set to be larger than the area of the magnetic sheet 13 to make it possible to cover the entire area of the magnetic sheet 13 with the first and second printed-circuit boards 31d1 and 31d2. The flexible plastic material such as polyimide or PET is used as base materials of the first and second printed-circuit boards 31d1 and 31d2 to make it possible to seal the magnetic sheet 13 in the first and second printed-circuit boards 31d1 and 31d2. In particular, when a ceramic material such as ferrite is used as a magnetic material, ceramic powder can be prevented from falling when the antenna module according to the present invention is mounted in an electronic device. As the first and second printed-circuit board, a rigid circuit board can be also used as a matter of course. When the antenna module is configured by using the rigid circuit board, a mechanical strength that is higher than that in the flexible printed-circuit board can be obtained.

### Another Embodiment

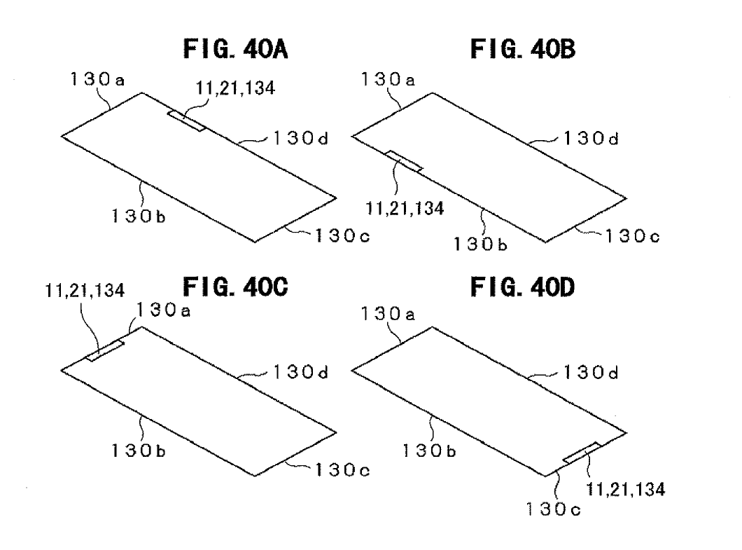

In the communication devices 1, 2, and 3 to which the present invention is applied, as shown in FIG. 40A, the antenna circuit boards 11 and 21 need not be arranged on the outer peripheral part 134 on the outer peripheral side 130d side of the outer peripheral sides 130a, 130b, 130c, and 130d sides, for example, the antenna circuit boards 11 and 21 may be arranged on the outer peripheral part 134 on the outer peripheral side 130a side as shown in FIG. 40B, on the outer peripheral part 134 on the outer peripheral side 130a side as shown in FIG. 40C, or on the outer peripheral part 134 on the outer peripheral side 130c side as shown in FIG. 40D.

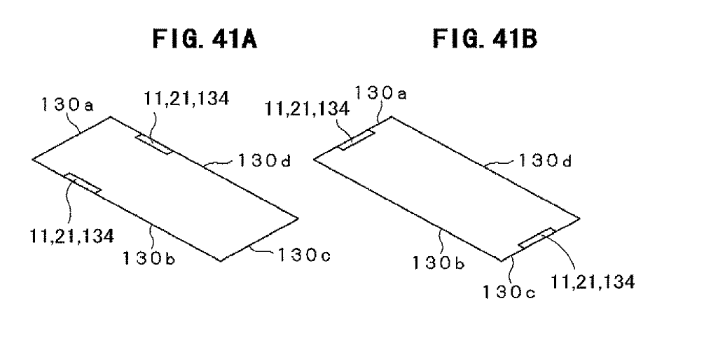

In the communication devices 1, 2, and 3 to which the present invention is applied, are described above, since the area of the antenna coil can be reduced, the plurality of antenna circuit boards 11 and 12 may be arranged. For example, as shown in FIG. 41A, the antenna circuit boards 11 and 21 may be arranged on the outer peripheral parts 134 on the outer peripheral side 130b side and the outer peripheral side 130d side, respectively, or, as shown in FIG. 41B, the antenna circuit boards 11 and 21 are arranged on the outer peripheral parts 134 on the outer peripheral side 130a side and the outer peripheral side 130c side, respectively, to electrically connect the antenna coils of the antenna circuit boards 11 and 21 to a communication processing unit.

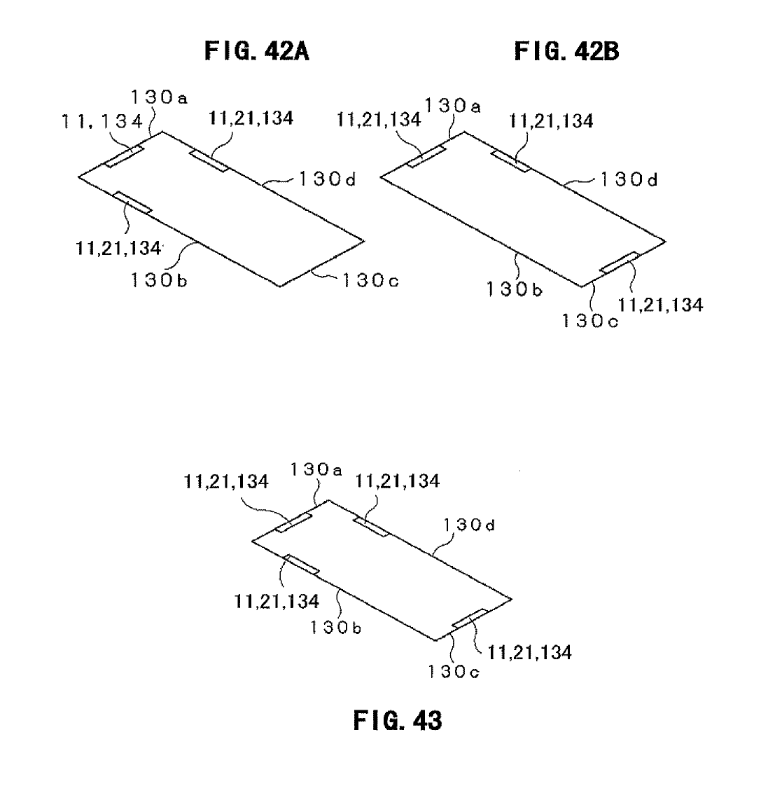

In the communication devices 1, 2, and 3 to which the present invention is applied, for example, as shown in FIG. 42A, the antenna circuit boards 11 and 21 are arranged on the outer peripheral part 134 on the outer peripheral side 130a side, the outer peripheral side 130b side, and the outer peripheral side 130d side, respectively, or, as shown in FIG. 42B, the antenna circuit boards 11 and 21 may be arranged on the outer peripheral parts 134 on the outer peripheral side 130a side, the outer peripheral side 130c side, and the outer peripheral side 130d side, respectively, to electrically connect the antenna coils of the antenna circuit boards 11 and 21 to the communication processing unit.

In the communication device to which the present invention is applied, for example, as shown in FIG. 43, the antenna circuit boards 11 and 21 may be arranged on the outer peripheral parts 134 on the outer peripheral side 130a side, the outer peripheral side 130b side, the outer peripheral side 130c side, and the outer peripheral side 130d side to electrically connect the antenna coils of the antenna circuit boards 11 and 21 to the communication processing unit.

### REFERENCE SIGNS LIST

1, 2, 3 . . . communication device, 11, 21 . . . antenna circuit board, 11a, 21a . . . antenna coil, 11a1, 11a2, 21a1, 21a2, 31a1, 31a2 . . . coil, 11b, 21b1, 21b2, 31b1, 31b2 . . . terminal unit, 11c1, 11c2, 22c1, 21c2 . . . opening, 23 . . . conductive line part, 12 . . . communication processing unit, 13, 133, 213 . . . magnetic sheet, 100 . . . wireless communication system, 121 . . . antenna, 122 . . . control circuit board, 130 . . . mobile phone, 130a-130d . . . outer peripheral side, 131 . . . housing, 132 . . . circuit board, 132a . . . central part, 134 . . . outer peripheral part, 201 . . . communication device, 211 . . . antenna circuit board, 211a . . . antenna coil, 211c . . . central part, 213 . . . magnetic sheet,

1. An antenna module that is incorporated in an electronic device and becomes communicable in response to a magnetic field transmitted from a transmitter comprising:
an antenna coil that is arranged on an outer peripheral part of a housing surface facing the transmitter of the electronic device and electromagnetically coupled to the transmitter; and
a magnetic sheet that attracts a magnetic field transmitted from the transmitter to the antenna coil, wherein
the antenna coil and the magnetic sheet are superimposed in a direction orthogonal to the housing surface such that the antenna coil is arranged to be closer to the transmitter than the magnetic sheet on an outer peripheral side of the housing surface and the magnetic sheet is arranged to be closer to the transmitter than the antenna coil on a center side of the housing surface, and
the antenna coil is arranged such that at least a part of a conductive line is superimposed in the direction orthogonal to the housing surface.

2. The antenna module according to claim 1, wherein
in the antenna coil, the magnetic sheet is arranged such that a part of a conductive line arranged on the housing surface side and a part of the conductive line arranged to be closer to the housing surface than the magnetic sheet is superimposed in a direction orthogonal to the housing surface through the magnetic sheet.

3. The antenna module according to claim 1, wherein
the antenna coil includes first and second coils formed on a printed-circuit board and winded in opposite directions through a connection point,
the first coil is arranged to be closer to an outer periphery of the housing surface than the second coil, and the magnetic sheet is inserted into an opening of the first coil, and
the second coil is folded such that a conductive line located on a center side of the housing surface with reference to the opening of the first coil is superimposed in a direction orthogonal to the conductive line of the first coil and the housing surface.

4. The antenna module according to claim 3, wherein
the first coil is folded such that a conductive line on the outer peripheral side of the housing surface of the first coil is on the transmitter side.

5. The antenna module according to claim 4, wherein
the printed-circuit board has a bent part depending on a thickness of the magnetic sheet.

6. The antenna module according to claim 4, wherein
an outer peripheral side of the housing surface of the first coil is folded such that a conductive line is on the electronic device side, and
the second coil is folded such that a conductive line on a central part side of the housing surface of the second coil is on the transmitter side.

7. The antenna module according to claim 1, wherein
a part of the conductive line of the antenna coil is formed on the first printed-circuit board,
a remaining part of the conductive line of the antenna coil is formed on the second printed-circuit board,
the magnetic sheet is laminated between the first printed-circuit board and the second printed-circuit board, and
the antenna coil is configured by connecting the conductive line formed on the first printed-circuit board and the conductive line formed on the second printed-circuit board to each other.

8. The antenna module according to claim 1, wherein
in the antenna coil, a first coil in which the magnetic sheet is inserted into an opening and a second coil that is arranged to be closer to a center of the housing surface than the first coil and in which the magnetic sheet is inserted into an opening are electrically connected to each other.

9. The antenna coil according to claim 8, wherein
on the antenna coil, an input/output terminal can connect the first coil and the second coil such that any one of a series connection state and a parallel connection state is selected.

10. The antenna module according to claim 8, wherein
the antenna coil is formed by using a conductive line on the printed-circuit board.

11. A communication device that is incorporated in an electronic device and becomes communicable in response to a magnetic field transmitted from a transmitter comprising:
an antenna coil that is arranged on an outer peripheral part of a housing surface facing the transmitter of the electronic device and electromagnetically coupled to the transmitter;
a magnetic sheet that attracts a magnetic field transmitted from the transmitter to the antenna coil; and
a communication processing unit that is driven by a current flowing in the antenna coil and communicates with the transmitter, wherein
the antenna coil and the magnetic sheet are superimposed in a direction orthogonal to the housing surface such that the antenna coil is arranged to be closer to the transmitter than the magnetic sheet on an outer peripheral side of the housing surface and the magnetic sheet is arranged to be closer to the transmitter than the antenna coil on a center side of the housing surface, and
the antenna coil is arranged such that at least a part of a conductive line is superimposed in the direction orthogonal to the housing surface.

12. A method of manufacturing an antenna module that is incorporated in an electronic device and becomes communicable in response to a magnetic field transmitted from a transmitter comprising:
the step of preparing an antenna coil that is arranged on an outer peripheral part of a housing surface facing the transmitter of the electronic device and electromagnetically coupled to the transmitter; and
the step of preparing a magnetic sheet that attracts a magnetic field transmitted from the transmitter to the antenna coil, wherein
the antenna coil and the magnetic sheet are superimposed in a direction orthogonal to the housing surface such that the antenna coil is arranged to be closer to the transmitter than the magnetic sheet on an outer peripheral side of the housing surface and the magnetic sheet is arranged to be closer to the transmitter than the antenna coil on a center side of the housing surface, and
the antenna coil is arranged such that at least a part of a conductive line is superimposed in the direction orthogonal to the housing surface.

13. The method of manufacturing an antenna module according to claim 12, wherein
the antenna coil includes first and second coils formed on a printed-circuit board and winded in opposite directions through a connection point,
the first coil is arranged to be closer to an outer periphery of the housing surface than the second coil, and the magnetic sheet is inserted into an opening of the first coil, and
the second coil is folded such that a conductive line located on a center side of the housing surface with reference to the opening of the first coil is superimposed in a direction orthogonal to the conductive line of the first coil and the housing surface.

14. The method of manufacturing an antenna module according to claim 12, wherein
a part of the conductive line of the antenna coil is formed on the first printed-circuit board,
a remaining part of the conductive line of the antenna coil is formed on the second printed-circuit board,
the magnetic sheet is laminated between the first printed-circuit board and the second printed-circuit board, and
the antenna coil is configured by connecting the conductive line formed on the first printed-circuit board and the conductive line formed on the second printed-circuit board to each other.
